(19) United States
(12) Patent Application Publication
(10) Pub. No.: US 2019/0340646 A1
(43) Pub. Date: Nov. 7, 2019

(54) METHOD AND APPARATUS FOR CONTENT-VIRALITY AMPLIFICATION

(71) Applicant: AFFINIO INC., Halifax (CA)

(72) Inventors: Stephen James Frederic HANKINSON, Hammonds Plains (CA); Timothy Andrew BURKE, Halifax (CA)

(21) Appl. No.: 16/465,212

(22) PCT Filed: Jan. 5, 2018
(86) PCT No.: PCT/CA2018/000004

§ 371 Date: May 30, 2019

Related U.S. Application Data
(60) Provisional application No. 62/442,716, filed on Jan. 5, 2017.

(51) Int. Cl. G06Q 30/02; G06F 16/2455; G06Q 50/00; H04L 12/58; H04L 29/08

(52) U.S. Cl. CPC G06Q 30/0254; G06F 16/2456; H04L 67/22; H04L 51/32; H04L 51/063; G06Q 50/01

(57) ABSTRACT

A method and apparatus for inducing expansion of audience of source contents posted in a social medium are disclosed. Upon posting the source contents, spontaneous audience are detected and content-coupled audience are determined; the content-coupled audience and the spontaneous audience are users of the social medium that accessed common contents, or contents of a common class, other than the source contents. A set of content-coupled audience is pruned to determine a set of prospective audience. Information relevant to the source contents is disseminated to the prospective audience resulting in audience gain. Processes of iterative-recursive exploration of multi-stratum content coupling are performed to further enhance the audience gain. An apparatus implementing the method may employ a single processor or multiple processors operating concurrently and exchanging intermediate results through commonly accessed buffers. Several variations of the method applying different criteria for pruning commonly-accessed content as well as content-coupled audience are disclosed.

### FIELD OF THE INVENTION

The present invention relates to machine interaction with social media. In particular, the invention is directed to spurring content-specific audience expansion in social media.

### BACKGROUND

Social media enable users to create and disseminate content, and to create online communities. The capabilities of the variety of available social media can be used for focused dissemination of specific contents to appropriate audience that are likely to benefit from the contents. There is a need, therefore, to explore methods of automated search for social-media like-minded users that would be attracted to selected contents.

### SUMMARY

In accordance with an aspect, the invention provides a method of audience amplification employing at least one processor. To start, source contents are posted in a social medium serving a plurality of users and providing a plurality of contents.

A set of spontaneous audience that individually accessed at least one of the source contents is detected through engaging the social medium. To expand the audience, a set of first-stratum contents that the spontaneous audience accessed are determined. The set of first-stratum contents is pruned to yield first-stratum relevant contents followed by detecting a set of first-stratum users that accessed the first-stratum relevant contents.

The set of first-stratum users is then pruned to yield a set of first-stratum prospective audience and information relevant to the source contents is communicated to the first-stratum prospective audience. The set of first-stratum prospective audience is tracked to identify first-stratum induced audience which constitute an audience gain.

The set of first-stratum contents is formed as a union of sets of contents accessed by individual users of the spontaneous audience. The set of first-stratum users is formed as a union of sets of users that accessed individual contents of the first-stratum relevant contents.

Pruning the set of first-stratum contents comprises activating processes of determining a gravitation score of each of the first-stratum contents and eliminating any first-stratum content that has a gravitation score below a predefined gravitation threshold. By definition, a gravitation score of a specific content is a count of users that accessed the specific content.

Pruning the set of first-stratum contents further comprises determining a content-similarity level of at least one of the first-stratum contents to the source contents and eliminating any first-stratum content having a content-similarity level below a predefined content-similarity threshold.

Pruning the set of first stratum users comprises determining an activity score of at least one of the first-stratum users and eliminating any first-stratum user having an activity score below a predefined activity threshold. An activity score of a specific user is defined as a count of contents that the specific user accessed.

Pruning the set of first stratum users further comprises determining a user-similarity level of at least one of the first-stratum users to the spontaneous audience and eliminating any first-stratum user having a user-similarity level below a predefined user-similarity threshold.

Further pruning of the set of first stratum users may be performed according to either of two procedures. The first procedure retains only first-stratum users within a relevant cluster to yield the first-stratum prospective audience; the first-stratum users being segmented into a predefined number of clusters of users with one of the clusters of users being selected as a most-relevant cluster. Segmenting the first-stratum users is preferably based on characterizing each of the first-stratum users by respective descriptors of predefined descriptor types. The second procedure determines a user-similarity level of at least one user of the first-stratum users to a predefined set of model consumers and eliminates any first-stratum user having a user-similarity level below a predefined user-similarity threshold. A user-similarity level for a specific user is a function of affinity levels of the specific user to individual model consumers of the set of model consumers.

The process of communicating the information relevant to the source contents to the first-stratum prospective audience comprises multicasting the source contents to the first-stratum prospective audience.

The first-stratum audience gain, which comprises the first-stratum induced audience as well as additional spontaneous audience, is determined by identifying users other than the already identified spontaneous audience that accessed the source contents.

To further expand the audience accessing the source contents, either of two recursive expansion procedures may be applied. According to a first recursive expansion procedure, audience expansion is based on finding prospective users that are content-coupled to the first-stratum induced audience. According to a second recursive expansion procedure, audience expansion is based on finding prospective users that are content-coupled to the first-stratum prospective users.

The first recursive expansion procedure comprises activating processes of tracking the first-stratum induced audience and determining a set of second-stratum contents that the first-stratum induced audience accessed. The set of second-stratum contents is pruned to yield second-stratum relevant contents. Subsequently, a set of second-stratum users that accessed the second-stratum relevant contents is detected and the set of second-stratum users is pruned to yield a set of second-stratum prospective audience. Information relevant to the source contents is then relayed to the second-stratum prospective audience. The set of second-stratum prospective audience is tracked to identify second-stratum induced audience which constitutes a further audience gain.

The second recursive expansion procedure comprises activating processes of tracking the first-stratum prospective audience and determining a set of second-stratum contents that the first-stratum prospective audience accessed. The set of second-stratum contents is pruned to yield second-stratum relevant contents. Subsequently, a set of second-stratum users that accessed the second-stratum relevant contents is detected and the set of second-stratum users is pruned to yield a set of second-stratum prospective audience. Information relevant to the source contents is then relayed to the second-stratum prospective audience. The set of second-stratum prospective audience is tracked to identify second-stratum induced audience which constitutes a further audience gain.

In accordance with another aspect, the invention provides a method of audience amplification comprising employing at least one processor for posting source contents in a selected social medium, detecting a set of spontaneous audience, identifying a set of prospective audience that is content-coupled to the spontaneous audience. The selected social medium serves a plurality of users and provides a plurality of contents.

The set of spontaneous audience comprises users that individually accessed at least one of the source contents. The set of spontaneous audience is detected during a time period that may be predefined or defined according to an attained size of the set of spontaneous audience. To induce and determine audience growth, a set of augmented audience is populated with the set of spontaneous audience and the method performs processes of expanding the set of augmented audience based on identifying and approaching users that are content-coupled to the spontaneous users. The following processes are performed:
(a) determining a set of first-stratum contents that the augmented audience accessed;
(b) content-pruning the first-stratum contents to retain only relevant contents;
(c) detecting a set of first-stratum users that accessed the relevant contents;
(d) user-pruning the first-stratum users to yield a set of prospective audience;
(e) relaying information relevant to the source contents to the prospective audience; and
(f) tracking the prospective audience to identify a set of induced audience.

The set of induced audience is then added to the set of augmented audience.

The processes of content-pruning comprise:
(a) determining for at least one of the first-stratum contents a gravitation score and a level of content-similarity to the source contents; and
(b) eliminating any first-stratum content having a gravitation score below a predefined gravitation threshold or a level of content-similarity below a predefined content-similarity threshold.

A gravitation score of a specific content is a count of users that accessed the specific content.

The processes of user pruning comprise:
(A) determining for each of the first-stratum users an activity score and a level of user-similarity to a predefined set of model consumers; and
(B) eliminating each first-stratum user having an activity score below a predefined activity threshold or a user-similarity level below a predefined user-similarity threshold.

An activity score of a specific user is a count of relevant contents that the specific user accessed.

So far, the method provides a first-stratum induced audience. The recursive expansion procedure may continue until it is determined that further audience gain is unlikely. Several schemes may be devised based on the teaching of the present specification. According to one scheme, a timer is cyclically reset to a reference reading (preferably zero) after a predefined interval of time defining a timer cycle and processes below are performed:
determining a set of K^{th}-stratum induced audience, K>1, during each of successive timer cycles;
determining audience gain as a count of the induced audience during each timer cycle;
determining a trend of audience gain over successive timer cycles; and
starting a new recursion subject to a determination that the trend satisfies a respective predetermined criterion; otherwise the recursive-expansion process is considered complete.

In accordance with a further aspect, the invention provides a method of inducing audience expansion. The method comprises posting a source content in a social medium and performing audience-expansion procedure employing at least one processor.

The social medium serves a plurality of users and provides a plurality of contents. The audience-expansion procedure comprises detecting initial audience that accessed the source content and applying multi-stratum search for prospective audience. To determine multi-stratum audience, starting with the initial audience as a base stratum, the at least one processor executes instructions for:
determining a set of contents accessed by audience of each stratum;
pruning the set of contents to retain a set of relevant contents;
detecting a set of users that accessed the set of relevant contents;
pruning the set of users to retain prospective audience;
communicating the source content to the prospective audience;
tracking, over a predefined interval of time, the prospective audience to detect induced audience; and
populating an immediately succeeding stratum with the induced audience.

The multi-stratum search continues subject to a determination that cumulative audience of all strata, excluding the initial stratum, exceeds a predefined audience-gain criterion.

In accordance with a further aspect, the invention provides an apparatus, coupled to a social medium, for audience amplification. The social medium serves a plurality of users and provides a plurality of contents. The apparatus comprises processors and memory devices storing processor-executable instructions causing the processors to post a source content in the social medium, identify initial users that spontaneously accessed the source content over a specified time interval, and populate a set of augmented audience to comprise the set of initial users. Repetitive cycles of a procedure of inviting further audience are then performed. During each cycle, the instructions cause the processors to: acquire first-stratum contents that the augmented audience accessed, filter the first-stratum contents to retain relevant contents; detect first-stratum users that accessed the relevant contents; prune the first-stratum users to yield prospective audience; communicate the source contents to the prospective audience; track the prospective audience to identify induced audience; and add the induced audience to the set of augmented audience.

The apparatus further comprises a cyclic timer configured to restart after a predefined interval of time defining the duration of each of the repetitive cycles. The instructions further cause the processors to measure audience gain during each cycle and determine a trend of audience gain over successive cycles. The procedure continues while the trend satisfies a respective predetermined criterion.

Thus, improved methods and systems for content-virality amplification have been provided.

### BRIEF DESCRIPTION OF THE DRAWINGS

Embodiments of the present invention will be further described with reference to the accompanying exemplary drawings, in which:

FIG. 1 illustrates a first method of content-virality amplification, in accordance with an embodiment of the present invention;

FIG. 2 is a block diagram of a second system of recursive-iterative content-virality amplification, in accordance with an embodiment of the present invention;

FIG. 3 is a block diagram of a third system of recursive-iterative content-virality amplification, in accordance with an embodiment of the present invention;

FIG. 4 is a visualization of recursive content-virality amplification, in accordance with an embodiment of the present invention;

FIG. 5 illustrates a first recursive audience-expansion scheme, in accordance with an embodiment of the present invention;

FIG. 6 illustrates a second recursive audience-expansion scheme, in accordance with an embodiment of the present invention;

FIG. 7 illustrates a third recursive audience-expansion scheme, in accordance with an embodiment of the present invention;

FIG. 8 illustrates further details of the third recursive audience-expansion scheme, in accordance with an embodiment of the present invention;

FIG. 9 illustrates a first method of recursive audience-expansion scheme, in accordance with an embodiment of the present invention;

FIG. 10 illustrates a second method of recursive audience-expansion scheme, in accordance with an embodiment of the present invention;

FIG. 11 illustrates a third method of recursive audience-expansion scheme, in accordance with an embodiment of the present invention;

FIG. 12 illustrates alternate two approaches for determining content-coupled prospective audience, in accordance with an embodiment of the present invention;

FIG. 13 is a visualization of the first method of recursive audience expansion, in accordance with an embodiment of the present invention;

FIG. 14 is a visualization of the second method of recursive audience expansion, in accordance with an embodiment of the present invention;

FIG. 15 is a visualization of recursive-iterative audience expansion, in accordance with an embodiment of the present invention;

FIG. 16 illustrates an exemplary set of user-characterization data, in accordance with an embodiment of the present invention;

FIG. 17 illustrates an exemplary set of users' content-access data, in accordance with an embodiment of the present invention;

FIG. 18 illustrates an exemplary collection of content-characterization data, in accordance with an embodiment of the present invention;

FIG. 19 illustrates content-coupled users, in accordance with an embodiment of the present invention;

FIG. 20 illustrates an exemplary software organization of an engine for content-virality amplification, in accordance with an embodiment of the present invention;

FIG. 21 illustrates an exemplary hardware organization of an engine for content-virality amplification, in accordance with an embodiment of the present invention;

FIG. 22 illustrates processes of user-group selection according to natural and guided segmentation of users for use in the engine of FIG. 20 and FIG. 21, in accordance with an embodiment of the present invention;

FIG. 24 illustrates a table of ranked relevant users based on affinity levels to model consumers, in accordance with an embodiment of the present invention;

FIG. 25 illustrates natural segmentation of users together with a set of model consumers;

FIG. 26 illustrates a set of users selected according to affinity to a set of model consumers, in accordance with an embodiment of the present invention;

FIG. 27 illustrates a recursive audience expansion process implemented at the engine of FIG. 20 and FIG. 21, in accordance with an embodiment of the present invention;

FIG. 28 illustrates a recursive audience expansion process implemented at the engine of FIG. 20 and FIG. 21 with pruned contents and pruned users, in accordance with an embodiment of the present invention;

FIG. 29 illustrates a conditional recursive-expansion process where content-coupled sets of users are selected to meet requisite content gravitation levels and user-activity levels, in accordance with an embodiment of the present invention;

FIG. 30 illustrates the content-coupled sets of users of FIG. 29 eliminating low-gravitation contents and low-activity users;

FIG. 31 illustrates successive content coupling in accordance with an embodiment of the present invention;

FIG. 32 is a flow chart of the basic processes of the engine of FIG. 20 and FIG. 21, in accordance with an embodiment of the present invention;

FIG. 33 is a flow chart of processes performed by the master module, module-I, module-II, and module-III of FIG. 20, in accordance with an embodiment of the present invention;

FIG. 34 is a flow chart detailing the recursive audience expansion process 3380, in accordance with an embodiment of the present invention;

FIG. 35 is a flow chart of processes of Module-II, in accordance with an embodiment of the present invention;

FIG. 36 is a flow chart of processes of determining candidate users, in accordance with an embodiment of the present invention;

FIG. 37 illustrates a processing assembly comprising processors interacting through buffers and a master processor, in accordance with an embodiment of the present invention;

FIG. 38 illustrates details of the master module and master processor, in accordance with an embodiment of the present invention;

FIG. 39 illustrates details of module-I and processor-I, in accordance with an embodiment of the present invention;

FIG. 40 illustrates details of module-II and processor-II, in accordance with an embodiment of the present invention;

FIG. 41 illustrates details of module-III and processor-III, in accordance with an embodiment of the present invention;

FIG. 42 illustrates audience size versus absolute time where a new audience-expansion cycle is initiated when the audience gain exceeds a predefined size threshold Δ*;

FIG. 43 illustrates audience size versus absolute time where a new audience-expansion cycle is initiated when the cyclic time exceeds a predefined time-interval threshold;

FIG. 44 illustrates audience size versus absolute time where a new audience-expansion cycle is initiated when the audience gain exceeds a predefined size threshold Δ* and the cyclic time exceeds a predefined time-interval threshold;

FIG. 45 illustrates timing of initiating cycles of recursive-audience expansion; in accordance with an embodiment of the present invention; and

FIG. 46 illustrates audience amplification during a first cycle of audience amplification, in accordance with an embodiment of the present invention.

### TERMINOLOGY

Social medium: The term refers to an Internet website and a collection of software applications accessible to a plurality of users enabling users to communicate and post contents. The apparatus and methods disclosed herein are applicable to a single social medium or to multiple social media.
User: The term user refers to an automaton, typically a human with a telecommunication device, interacting with a social medium.
Content: Information in the form of text, image, audio signal, and/or video signal, treated as a single entity, is referenced as “content” (singular). A user of a social medium may post multiple “contents” in a single social medium or in multiple social media.
Source contents: Contents posted for the purpose of dissemination, to which the methods of the present invention are applied, are referenced as “source contents” or “root contents”.
Content type: Contents relevant to a similar theme or a similar subject matter are said to be of a same “content type” or “content class”.
Content-coupled users: Users that accessed a common content are said to be “content-coupled users”.
Class-coupled users: Users that accessed different contents of a specific class of contents (specific type of contents) are said to be “class-coupled users”.
User segmentation/clustering: A process of grouping users based on descriptors of the users is referenced as “segmentation” or “clustering”. The descriptors of the users may relate to several aspects such as income, education, interest, and social activities. A user may be characterized according to a vector of an arbitrary number of descriptors.
Attracted user: The term refers to a user that accessed a source content under consideration.
Audience: The term “audience” is used herein to refer to attracted users (in the plural sense)
Spontaneous audience: The term refers to attracted users that accessed a source content without being prompted.
Induced audience: The term refers to attracted users that accessed a source content after being approached by the engine of the present invention.
Prospective user: A user targeted on the basis of content-coupling to an already attracted user is a prospective user. A prospective user that actually accesses a source content becomes an attracted user.
Audience expansion: The term refers to the objective of increasing the number of attracted users to (substantially) exceed the size of the spontaneous audience (the number of spontaneously attracted users).
Content-virality amplification: The term is synonymous with the term “audience expansion”.
Multi-stratum audience expansion: The term refers to hierarchical search for prospective users. Users that are content-coupled to spontaneous audience are said to be stratum-1 users. Stratum-1 users that actually access a source content are said to be stratum-1 audience. Users that are content coupled to stratum-1 audience are said to be stratum-2 users. Stratum-2 users that actually access a source content are said to be stratum-2 audience, and so on. The number of strata is judicially selected.
Recursive audience expansion: A process of using data of a given stratum to seek users of an immediately succeeding stratum is referenced as a “recursive audience expansion” process.
Iterative audience-expansion process: A process of restarting the entire audience-expansion process, seeking to expand the already known cumulative attracted audience (spontaneous audience and induced audience) instead of seeking to expand the spontaneous audience is referenced as an “iterative audience- expansion process”.
Iterative-recursive audience expansion: The term refers to an iterative audience-expansion process where each iteration extends to more than one stratum.
Content-pruning: The term refers to filtering a set of contents to retain only contents considered to be relevant.
User-pruning: The term refers to filtering a set of users to retain only users considered to be interested in a source content.
K^{th}-stratum contents, K≥1: Contents—other than the source contents—accessed by spontaneous audience are referenced as first-stratum contents (stratum-1 contents). Contents, other than stratum-1 contents accessed by stratum-1 users, are referenced as second-stratum contents (stratum-2 contents) and so on.
K^{th}-stratum relevant contents, K≥1: The term refers to pruned K^{t}-stratum contents (retained contents of the K^{th}-stratum contents).
K^{th}-stratum users, K≥1: The term refers to users—other than (K−1)^{th} users—that accessed K^{th}-stratum relevant contents; the spontaneous audience may be treated as stratum-0 users.
K^{th}-stratum prospective users, K≥1: The term refers to pruned K^{th}-stratum users.
Gravitation score: A gravitation score of a specific content is a number of users that accessed the specific content.
Activity score: An activity score of a user is a number of relevant contents that the user accessed.
Model consumer: A model consumer is a user considered to an ideal consumer of the source contents.
Mutual affinity level: An affinity level of a first user to a second user (or vice versa) is a measure of similarity of the two users. With each user characterized by a respective descriptor vector, the affinity level may be determined as a function of the Euclidean distance between the two descriptor vectors, as a function of the dot product of the two descriptor vectors, or as a function of both the Euclidean distance and the dot product. The definition also applies to a user and a model consumer; a model consumer is characterized by a descriptor vector. The affinity level is preferably normalized to have values between 0.0 and 1.0, where a value of 1.0 indicates highest similarity and a value of 0.0 indicates full dissimilarity.

Processor: The term processor refers to a single hardware processor or an assembly of hardware processors which may be operated concurrently either independently or according to other multi-processing arrangements.

### REFERENCE NUMERALS

100: Overview of a method for content-virality amplification
110: Source contents
112: Process of presenting source contents
120: Process of identifying users attracted to source contents
130: Process of finding prospective audience (social-media users interested in contents similar to contents that attracted previous audience)
140: Process of approaching prospective audience 130
170: Process of revisiting process 120 after a specified delay Δ₁
200: Block diagram of a first system of recursive-iterative content-virality amplification
220: Process of identifying a set of currently attracted users (initially, the set would include only the spontaneous audience)
225: Process of initializing a set of current prospective audience to be the set of currently attracted users
230: Process of finding new prospective audience (social-media users interested in contents similar to contents that attracted the current prospective audience)
240: Process of accumulating the new prospective audience identified in each recursive cycle traversing processes 230, 240, 280, and 250
245: Process of determining whether to branch to process 250 to start a new recursion or branch to process 260 to communicate with prospective users
250: Process of starting a new recursion by using the new prospective audience as the current prospective audience.
260: Process of approaching all prospective audience identified during the recursive cycles
270: Process of revisiting process 220 after a delay Δ₁
300: Block diagram of a second system of recursive-iterative content-virality amplification
320: Process of identifying a set of all attracted users (initially, the set would include only the spontaneous audience)
325: Process of initializing a set of currently attracted users as the set of all attracted users
330: Process of finding prospective audience (social-media users interested in contents similar to contents that attracted the currently attracted users)
340: Process of approaching prospective audience
345: Process of determining whether to start a new recursion or a new iteration
350: Process of applying an artificial delay Δ₂ between approaching a specific prospective audience and detecting effect (new attracted audience)
360: Process of identifying and accumulating newly attracted users (induced audience)
364: Process of starting a new recursion by using the new attracted audience as the currently attracted audience.
370: Applying an artificial delay Δ₁ between approaching prospective audience and revisiting process 320 to restart an iterative sequence of processes
400: Diagram illustrating recursive content-virality amplification
430: Spontaneous audience accessing source contents
440: A set of contents, other than the source contents, accessed by spontaneous audience
441: Relevant content of set 440
442: Unrelated content of set 440
450: A set of users that accessed a selected subset of contents 440
451: Related user
452: Uninterested user
460: A set of contents accessed by selected users of set 450
461: Relevant content of set 460
462: Unrelated content of set 460
470: A set of users that accessed a selected subset of contents 460
471: Related user
472: Uninterested user
500: First recursive audience-expansion scheme
510: Spontaneous audience S₀ of source contents 110
511: Process of identifying users similar to spontaneous audience 510
512: Stratum-1 users; users similar to spontaneous audience
521: Process of identifying users similar to stratum-1 users 512
522: Stratum-2 users; users similar to stratum-1 users 512
531: Process of identifying users similar to stratum-2 users 522
532: Stratum-3 users; users similar to stratum-2 users 522
541: Process of identifying users similar to stratum-3 users 532
542: Stratum-4 users; users similar to stratum-3 users 532
571: Process of identifying users similar to users of an immediately preceding stratum
572: Users similar to users of an immediately preceding stratum
580: Overall prospective audience
600: second recursive audience-expansion scheme
610: Spontaneous audience S₀ of source contents 110
611: Process of identifying users similar to spontaneous audience 610
612: Stratum-1 users similar to spontaneous audience
614: Process of approaching users 612
620: Induced audience Q₁ resulting from process 614
621: Process of identifying users similar to induced audience 620
622: Stratum-2 users similar to induced audience 620
624: Process of approaching users 622
630: Induced audience Q₂ resulting from process 624
631: Process of identifying users similar to induced users 630
632: Stratum-3 users similar to induced audience 630
634: Process of approaching users 632
640: Induced audience Q₃ resulting from process 634
641: Process of identifying users similar to induced users 640
642: Stratum-4 users similar to induced audience 640
644: Process of approaching users 642
670: Induced audience Qₖ₋₁ resulting from a process of approaching users at stratum-(k−1), k>4
671: Process of identifying users similar to induced users 670
672: Users similar to induced audience 670
680: Overall prospective audience
690: Overall induced audience
700: Third recursive audience-expansion scheme
710: Spontaneous audience S₀
720: Stratum-1 induced audience Θ₁
725: Stratum-1 attracted users S₁ comprising spontaneous audience S₀ and induced audience Θ₁; (S₁=S₀+Θ₁)
730: Stratum-2, induced audience Θ₂ resulting from approaching users similar to Θ₁ in addition to natural increment of spontaneous audience and stratum-1 attracted audience
735: Stratum-2 attracted users S₂ comprising S₁ and induced audience Θ₂; S₂=S₁+Θ₂
740: Stratum-3, induced audience Θ₃ resulting from approaching users similar to Θ₂ in addition to natural increment of spontaneous audience and attracted audience
745: Attracted users S₃ comprising S₂ and stratum-3 induced audience Θ₃; S₃=S₂+Θ₃
790: Stratum-k induced audience Θₖ, k>3, resulting from approaching users similar to previous induced audience in addition to natural audience increment
792: Attracted users Sₖ comprising Sₖ and induced audience Θₖ; Sₖ=Sₖ₋₁+Θₖ
800: Third recursive audience-expansion scheme—further details
811: Process of identifying additional users 812 similar to attracted users S₀
812: Additional users similar to attracted users S₀
814: Process of approaching users 812
821: Process of identifying users 822 similar to attracted users S₁
822: Additional users similar to attracted users S₁
824: Process of approaching users 822
831: Process of identifying users 832 similar to attracted users S₂
832: Additional users similar to attracted users S₂
834: Process of approaching users 832
841: Process of identifying users 842 similar to attracted users S₃
844: Process of approaching users 842
891: Process of identifying users 892 similar to attracted users Sₖ₋₁
892: Additional users similar to attracted users Sₖ
900: First method of recursive audience expansion
904: Process of identifying spontaneous audience S₀
906: Process of finding a set Γ₁ of users that are content coupled to spontaneous users S₀
907: Process of pruning set Γ₁ to retain a set γ₁ of prospective audience content-coupled to spontaneous audience S₀
912: Process of finding a set Γ₂ of users that are content coupled to set γ₁ of prospective audience
914: Process of pruning set Γ₂ to retain a set γ₂ of prospective audience content coupled to set γ₁ of prospective audience
922: Process of finding a set Γ₃ of users that are content-coupled to set γ₂ of prospective audience

924: Process of pruning set Γ₃ to retain a set γ₃ of prospective audience content coupled to set γ₂ of prospective audience
932: Process of finding a set Γ₄ of users that are content coupled to set γ₃ of prospective audience
1000: Second method of recursive audience expansion
1004: Process of identifying spontaneous audience S₀
1006: Process of finding a set Γ₁ of users similar to spontaneous users S₀
1007: Process of pruning set Γ₁ to retain a set γ₁ of prospective audience similar to spontaneous audience S₀
1008: Process of approaching set γ₁ of prospective audience
1010: Process of identifying induced audience Q₁ resulting from process 1008
1012: Process of finding a set Γ₂ of users similar to induced audience Q₂
1014: Process of pruning set Γ₂ to retain a set γ₂ of prospective audience similar to induced audience Q₁
1015: Process of approaching set γ₂ of prospective audience
1020: Process of identifying induced audience Q₂ resulting from process 1015
1022: Process of finding a set Γ₃ of users similar to induced audience Q₂
1024: Process of pruning set Γ₃ to retain a set γ₃ of prospective audience similar to induced audience Q₂
1025: Process of approaching set γ₃ of prospective audience
1030: Process of identifying induced audience Q₃ resulting from process 1025
1032: Process of finding a set Γ₄ of users similar to induced audience Q₃
1034: Process of pruning set Γ₄ to retain a set γ₄ of prospective audience similar to induced audience Q₃
1035: Process of approaching set γ₄ of prospective audience
1100: Third method of recursive audience expansion
1104: Process of identifying spontaneous audience S₀
1106: Process of finding a set Γ₁ of users similar to spontaneous users S₀
1107: Process of pruning set Γ₁ to retain a set γ₁ of prospective audience similar to spontaneous audience S₀
1108: Process of approaching set γ₁ of prospective audience
1110: Process of identifying induced audience Θ₁ resulting from process 1108
1111: Count, S₁, of all stratum-1 attracted users
1112: Process of finding a set Λ₂ of additional users similar to attracted users S₁
1114: Process of pruning set Δ₂ to retain a set λ₂ of additional prospective audience similar to attracted users S₁
1115: Process of approaching set λ₂ of prospective audience
1120: Process of identifying induced audience Θ₂ resulting from process 1015
1121: Count S₂, of all stratum-2 attracted users
1122: Process of finding a set Λ₃ of additional users similar to attracted users S₂
1124: Process of pruning set Λ₃ to retain a set λ₃ of additional prospective audience similar to attracted users S₂
1125: Process of approaching set λ₃ of prospective audience
1130: Process of identifying induced audience Θ₃ resulting from process 1025
1131: Count S₃, of all stratum-3 attracted users
1132: Process of finding a set Λ₄ of additional users similar to attracted users S₃
1134: Process of pruning set Λ₄ to retain a set λ₄ of additional prospective audience similar to attracted users S₃
1135: Process of approaching set λ₄ of prospective audience
1200: Options of generating prospective audience
1202: Method of determining a set of prospective audience based on direct content-coupling to a set of currently attracted users
1204: Method of determining a set of prospective audience based on multi-level content coupling to currently attracted users.
1210: Currently attracted users including spontaneous audience and induced audience
1220: Prospective audience based on direct content-coupling to currently attracted users
1225: Process of updating set of currently attracted audience
1230: Currently attracted users including spontaneous audience and induced audience
1250: Process of updating set 1230 of currently attracted audience
1260: First level prospective audience
1270: Second level prospective audience
1280: Total prospective audience
1300: Visualization of first method recursive audience expansion
1320: Set of spontaneous audience
1322: A user attracted to source contents
1324: Process of identifying prospective audience that are content-coupled to spontaneous audience
1330: Stratum-1 prospective audience based on similarity to spontaneous audience
1333: Responsive user of stratum-1 of prospective audience
1340: Process of identifying prospective audience that are content-coupled to Stratum-1 prospective audience
1350: Stratum-2 similar users (prospective audience) based on similarity to stratum-1 similar users
1353: Responsive user of stratum-2 of prospective audience
1355: Process of accumulating all prospective audience to be approached
1360: Total stratum-2 attracted users
1400: Visualization of second method of recursive audience expansion
1432: Uninterested user of stratum-1 similar users
1433: Interested user of stratum-1 similar users
1435: Process of identifying stratum-1 induced audience among stratum-1 similar users (after an artificial delay Δ₂)
1440: Set of already attracted users including induced audience (responsive users) and spontaneous audience
1444: Process of identifying prospective audience based on similarity to stratum-1 responsive users
1450: Stratum-2 similar users (prospective audience) based on similarity to stratum-1 responsive users
1452: Uninterested user of stratum-2 similar users
1453: Interested users of stratum-2 similar users
1455: Process of identifying stratum-2 induced audience among stratum-2 similar users 1450 (after an artificial delay Δ₂)
1460: Set of already attracted users including spontaneous audience, stratum-1 induced audience and stratum-2 induced audience
1500: Visualization of recursive-iterative audience expansion
1530: All prospective audience
1550: Augmented audience (set of all attracted users)
1600: Set of user characterization data
1610: User index
1620: User identifier
1622: IP address
1640: User descriptors
1700: Set of users' content-access characterization data
1730: Identifiers of contents accessed by relevant users
1732: Content index
1800: Content characterization data
1810: Content index
1820: Content identifier
1822: Hyperlink name
1830: Content metadata
1832: Metadata index
1900: Content-based users' similarity
1910: Content class
1920: Specific content
1922: Content similar to specific content
1940: Content-coupled users
1950: Class-coupled users
1960: Class-content-coupled users
2000: Marketing-intelligence-system implementation
2010: Module-I for identifying users attracted to specific contents
2020: Module-II for finding similar-interest users
2030: Module-III for communicating with similar-interest users
2080: Engine for content-virality amplification
2090: Social-media platform
2100: Implementation of engine for content-virality amplification
2110: Master module
2112: Instruction set for placing source content in a social media storage device
2114: Instruction set for segmenting a set of attracted users (spontaneous and induced audience)
2116: Instruction set for selecting a preferred subset of the set of attracted users (spontaneous and induced audience)
2150: Processing assembly (preferably multiple hardware processors)
2200: Processes of natural and guided segmentation of users
2210: Processes of natural segmentation
2220: Process of acquiring a description vector of each user of a plurality of users attracted to
specific contents
2224: Process of segmenting the plurality of attracted users into user groups according to
inherent mutual-affinity levels
2226: Process of specifying descriptor vectors for a number of model consumers
2228: Process of selecting the user group closest to the model consumers as a preferred user group
2240: Processes of guided segmentation of users
2244: Process of determining affinity levels of each user to each model consumer
2245: Target users selection option
2246: Process of selecting each user having an affinity level exceeding a predefined affinity threshold to form a preferred user group
2224: Process of ranking users and selecting users according to rank
2300: Table of user descriptors
2340: Set of relevant user descriptors
2400: Ranking users according to affinity to model consumers
2420: Affinity levels to individual model consumers
2425: Model consumer (one of M1, M2, M3, and M4)
2428: Affinity level to a single model consumer
2430: Highest affinity level
2440: User rank
2500: Natural segmentation
2510: Attracted users
2530: Preferred group of users
2600: Guided segmentation
2630: Preferred group of users based on affinity to model consumers
2700: Representation of a procedure implemented by the engine for content-virality amplification employing the first method of audience amplification
2712: A set of spontaneous audience
2720: A set of stratum-1 contents, defined as contents—other than the source contents—accessed by the spontaneous audience
2725: A set of stratum-1 similar-interest users, defined as users that are content-coupled, through stratum-1 contents, to the spontaneous audience
2730: A set of stratum-2 contents, defined as contents—other than stratum-1 contents—accessed by stratum-1 similar-interest users
2735: A set of stratum-2 similar-interest users, defined as users that are content-coupled, through stratum-2 contents, to stratum-1 similar-interest users
2800: Representation of a procedure implemented by the engine for content-virality amplification with pruned contents and pruned users employing the first method of audience amplification
2812: A set of pruned spontaneous audience
2820: A set of stratum-1 pruned contents, defined as pruned contents—other than the source contents—accessed by the pruned spontaneous audience
2825: A set of stratum-1 pruned similar-interest users, defined as users that are content-coupled, through stratum-1 contents, to the pruned spontaneous audience
2830: A set of stratum-2 pruned contents, defined as contents—other than stratum-1 pruned contents—accessed by pruned stratum-1 similar-interest users
2835: A set of stratum-2 pruned similar-interest users, defined as users that are content-coupled, through stratum-2 pruned contents, to stratum-1 pruned similar-interest users
2900: Conditional recursive extension process
2910: A set of spontaneous audience
2911: Individual attracted users within the set of spontaneous audience
2920: Set of contents accessed by the spontaneous audience
2921: Individual contents of set 2920
2930: Set of users that are content-coupled to the set of spontaneous audience
2931: Individual users of set 2930
3000: Results of conditional recursive-expansion process
3020: Relevant content
3030: Prospective audience
3100: Recursive determination of similar-interest users based on content coupling (Module II)
3115: Spontaneous audience
3120: Stratum-1 contents
3125: Stratum-1 similar-interest users
3130: Stratum-2 contents
3135: Stratum-2 similar-interest users
3140: Stratum-3 contents
3145: Stratum-3 similar-interest users
3150: Stratum-4 contents
3155: Stratum-4 similar-interest users
3200: Basic processes of content-virality amplification
3210: Process of receiving source content
3212: Process of initializing a set of attracted users as an empty set
3220: Process of determining a set of users attracted to the source content
3230: Process of determining whether the set of attracted users contains a significant number of attracted users
3232: Process of waiting for a predefined time interval before revisiting process 3230
3234: Process of initializing a set of prospective audience
3238: Process of initializing a current set of users as a set of attracted users
3240: Process of finding new contents accessed by the current set of users
3242: Process of pruning a list of new contents according to similarity to the source content
3250: Process of finding a set of new users attracted to the new contents to overwrite the current set of users
3252: Process of pruning the set of new users
3260: Process of adding the pruned set of new users to the set of prospective audience
3264: Process of counting recursions 3255 and determining whether a predefined number of recursions has been reached
3270: A recursion traversing processes 3240, 3242, 3250, 3252, and 3260
3300: Processes of the master module, module-I, module-II, and module-III
3305: Process of accessing a network to engage social media and exhibit source contents
3310: Processes of master module
3320: Process of providing source contents
3325: Process of initializing a set of attracted users
3330: Process of tracking cyclic time.
3340: Process of starting a new iteration
3350: Process of tracking users accessing source contents
3360: Process of updating the set of attracted users and counting the attracted number α of users
3365: Process of determining whether the number of spontaneous audience exceeds a predefined size threshold Δ* and the cyclic time exceeds a predefined time interval T*
3372: Process of resetting cyclic time T to zero
3380: Process of executing recursive audience expansion modules (Module-I and Module-II)
3390: Process of communicating with prospective audience
3410: Process of receiving the set of current audience
3420: Process of initializing a set of current users as the set of current audience
3425: Process of initializing a set of prospective audience as an empty set
3430: Process of determining a set of relevant contents accessed by the set of current users
3440: Process of determining a set of candidate users accessing the relevant contents
3450: Process of adding the candidate users to the set of prospective audience
3465: Process of counting recursions and determining whether a preset limit of the number of recursions has been reached
3470: Process of determining whether a significant number of candidate users has been reached
3480: Process of refreshing the set of current users to constitute the candidate users
3485: Recursion
3500: Details of process 3430 (determining a set of relevant contents)
3510: Process of determining further contents accessed by each current user
3520: Process of determining the union of further contents accessed by the set of current users
3530: Process of determining a similarity level of each of the further contents to the source content
3540: Process of retaining each of the further contents that has a similarity level above a predefined similarity threshold to yield a set of relevant contents
3550: Process of determining a user-attraction score for each of the relevant contents
3560: Process of pruning the set of relevant contents to retain each of the relevant contents that has a user-attraction score above a predefined attraction threshold
3600: Details of process 3440 (determining a set of candidate users)
3610: Processes of determining for each relevant content a respective set of further users that accessed the relevant content
3620: Process of determining the union of sets of further users
3630: Process of determining an activity score of each further user based on number of accessed contents and access duration
3640: Process of pruning the sets of further users to retain each of the further users that has an activity score exceeding a predefined activity threshold
3700: Details of processing assembly 2150
3705: Master processor
3710: Processor-I executing instructions of Module-I
3711: Buffer accessed by the Master Processor and Processor-I
3712: Buffer segment holding data relevant to specific content
3714: Buffer segment holding data relevant to attracted users identified in Module-I
3720: Processor-II executing instructions of Module-2
3721: Buffer accessed by the Master processor and Processor-II
3722: Buffer segment holding data relevant to a segment of reference users
3724: Buffer segment holding data relevant to contents accessed by the set of reference users
3730: Processor-III executing instructions of Module-III
3731: Buffer accessed by the Master processor and Processor-III
3734: Data relevant to prospective audience and source contents
3800: Implementation of Master Module
3810: Network-interface module (software instructions)
3820: Module for acquiring source contents
3830: Module for acquiring characteristics of model consumers
3840: Module for segmenting users based on user traits
3850: Module for identifying a target group of users
3860: Module for tracking cyclic time
3900: Implementation of Module-I
3910: Memory storing network-interface module
3920: Memory storing a module for tracking users attracted to specific contents
3930: Module for updating the set of attracted users and determining changes of audience count
4000: Implementation of Module-II
4010: Memory storing a network-interface module
4030: Memory storing a module for determining a set of relevant contents accessed by a given set of users
4100: Implementation of Module-III
4110: A network-interface module stored in a memory device
4120: Data relevant to prospective audience stored in a memory device
4140: A module for multicasting to prospective audience stored in a memory device
4200: Audience growth with audience-expansion cycles initiated according to audience gain
4210: Size of spontaneous audience
4220: Audience gain after a first audience-expansion cycle
4230: Audience gain after a second audience-expansion cycle
4240: Audience gain after a third audience-expansion cycle
4300: Audience growth with audience-expansion cycles initiated according to cycle duration
4310: Size of spontaneous audience
4320: Audience gain after a first audience-expansion cycle
4330: Audience gain after a second audience-expansion cycle
4340: Audience gain after a third audience-expansion cycle
4400: Audience growth with audience-expansion cycles initiated according to audience gain and cycle duration
4410: Size of spontaneous audience
4420: Audience gain after a first audience-expansion cycle
4430: Audience gain after a second audience-expansion cycle
4440: Audience gain after a third audience-expansion cycle
4510: Processes activated during a first cycle of audience expansion
4512: Observation time for detecting spontaneous audience, i.e., users attracted to the source contents
4514: Duration of process of finding stratum-1 prospective audience, defined as users that are content-coupled to the spontaneous audience, i.e., users accessing contents—referenced as stratum-1 contents—which are similar to the contents other than the source contents that the spontaneous audience accessed
4516: Duration of processes of communicating with stratum-1 prospective audience and detecting stratum-1 induced audience
4520: Processes activated during a second cycle of audience expansion
4524: Duration of process of finding stratum-2 prospective audience, defined as users that are content-coupled to the stratum-1 induced audience, i.e., users accessing contents—referenced as stratum-2 contents—which are similar to the contents other than the stratum-1 contents that the stratum-1 induced audience accessed
4526: Duration of processes of communicating with stratum-2 prospective audience and detecting stratum-2 induced audience
4530: Processes activated during a third cycle of audience expansion
4534: Duration of process of finding stratum-3 prospective audience, defined as users that are content-coupled to the stratum-2 induced audience, i.e., users accessing contents—referenced as stratum-3 contents—which are similar to the contents other than the stratum-2 contents that the stratum-2 induced audience accessed
4536: Duration of processes of communicating with stratum-3 prospective audience and detecting stratum-3 induced audience
4600: Exemplary audience amplification during a first cycle of iterative-recursive amplification
4612: Spontaneous audience detected during observation period 4512
4622: Spontaneous audience at end of time period 4514
4624: Hypothetical growth of spontaneous audience in absence of communicating with prospective audience
4634: Envisaged growth of attracted audience, combining both the spontaneous audience and induced audience, attributed to communication with prospective audience
4640: Induced audience component of audience growth

### DETAILED DESCRIPTION

The invention provides methods and apparatus for audience amplification in social-media environment.

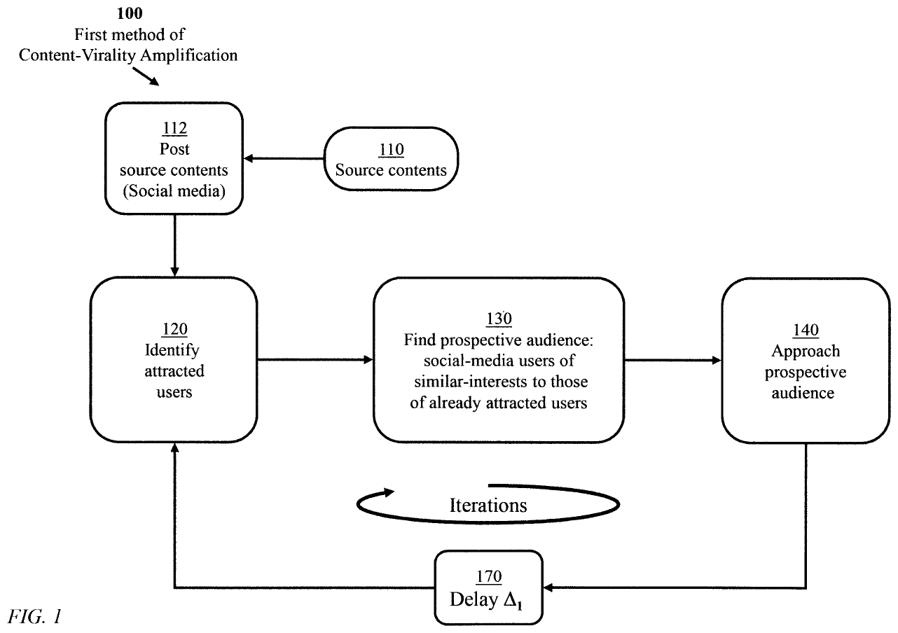

FIG. 1 illustrates a first method 100 of content-virality amplification using an engine comprising at least one processor. The engine is communicatively coupled to a social medium that serves a plurality of users and provides a plurality of contents. An operator of the engine activates the engine to post source contents 110 in a social medium (process 112), detect audience (users) visiting the contents, and engage the social medium to expand the audience. The engine executes a process 120 to identify users of the social medium that have spontaneously accessed the source contents. The engine then executes a process 130 to find prospective audience, i.e., the social-medium users interested in the source contents and similar contents. The engine communicates the source contents and/or information relevant to the source content to the prospective audience (process 140). Process 120 is then revisited after a specified delay denoted Δ₁ (process 170).

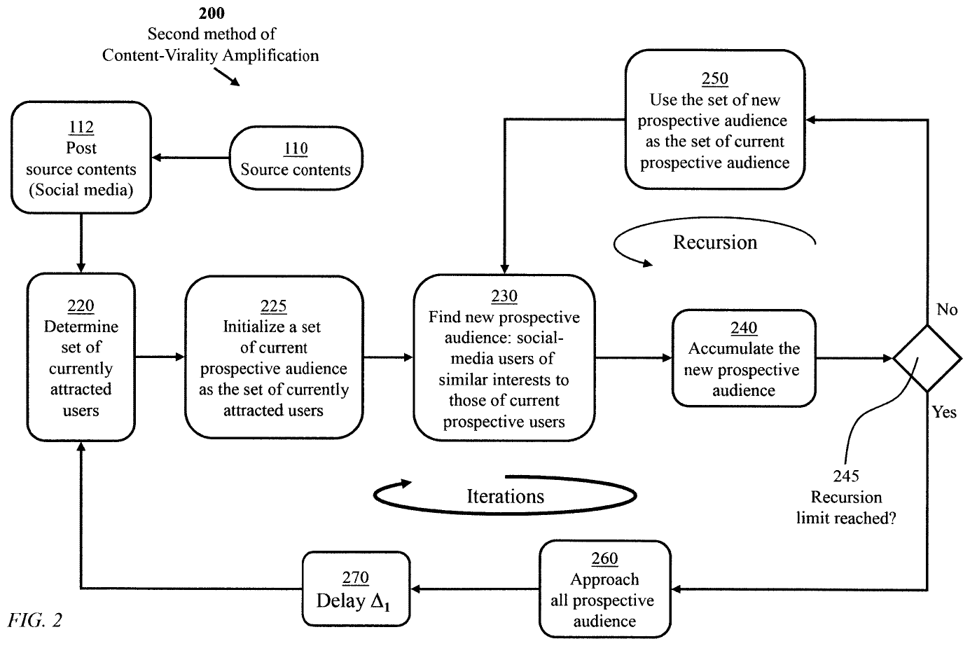

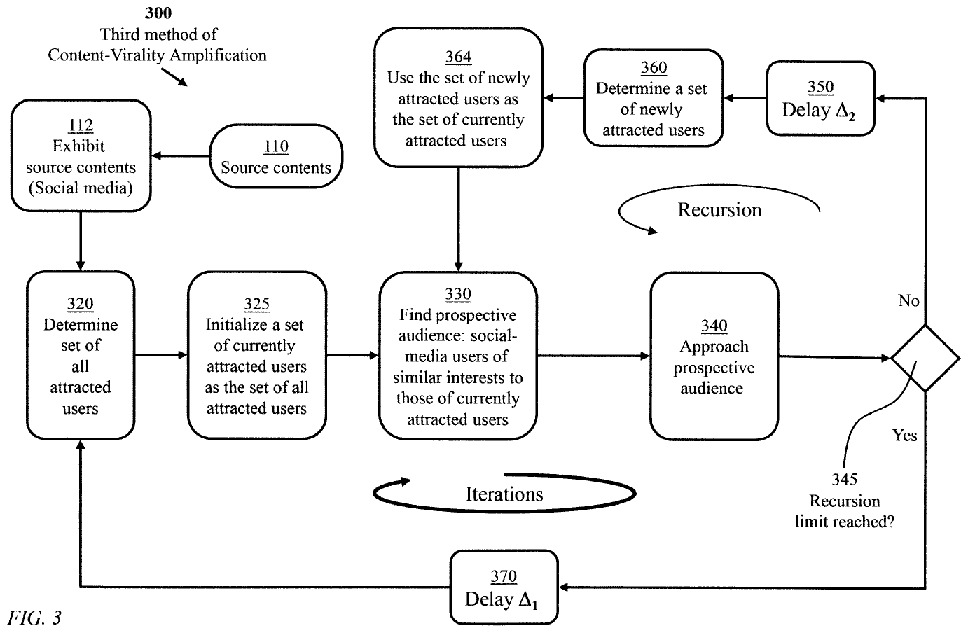

FIG. 2 is a block diagram of a second method 200 of recursive-iterative content-virality amplification. An operator of the engine activates the engine to post source contents 110 in a social medium (process 112), detect audience (users) visiting the contents, and engage the social medium to expand the audience. The engine executes a process 220 to identify a set of currently attracted users of the social medium that accessed the source contents. Initially, the set would include only spontaneous audience.

Process 225 initializes a set of current prospective audience to be the set of currently attracted users. Process 230 finds a new set of prospective audience which comprises users interested in contents similar to contents that attracted the current prospective audience. Process 240 accumulates data relevant to the new prospective audience. Process 245 determines whether to branch to process 250 to start a new recursion or branch to process 260 to communicate with prospective users.

Process 250 starts a new recursion by using the new prospective audience as the current prospective audience. Process 260 establishes communication with all prospective audience identified during successive recursive cycles. Process 270 revisits process 220 after an artificial delay Δ₁.

FIG. 3 is a block diagram of a third method 300 of recursive-iterative content-virality amplification. Process 320 identifies a set of all attracted users; initially, the set would include only the spontaneous audience. Process 325 initializes a set of currently attracted users as the set of all attracted users. Process 330 finds prospective audience comprising social-media users interested in contents similar to contents that attracted the currently attracted users. Process 340 communicates with prospective audience. Process 345 determines whether to start a new recursion or a new iteration.

Process 350 applies an artificial delay Λ₂ between communicating with a specific prospective audience and detecting effect of the communication, i.e., detecting new attracted audience). Process 360 identifies and accumulates newly attracted users (induced audience). Process 364 starts a new recursion by using the new attracted audience as the currently attracted audience.

Process 370 applies an artificial delay Δ₁ between the time of communicating with prospective audience and the time of revisiting process 320 to restart an iterative sequence of processes.

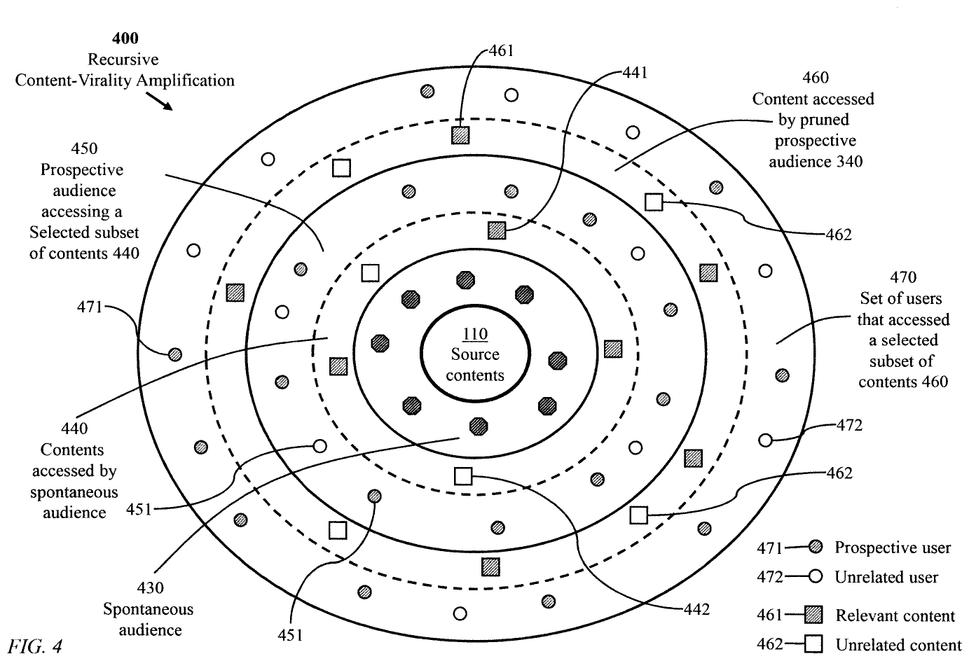

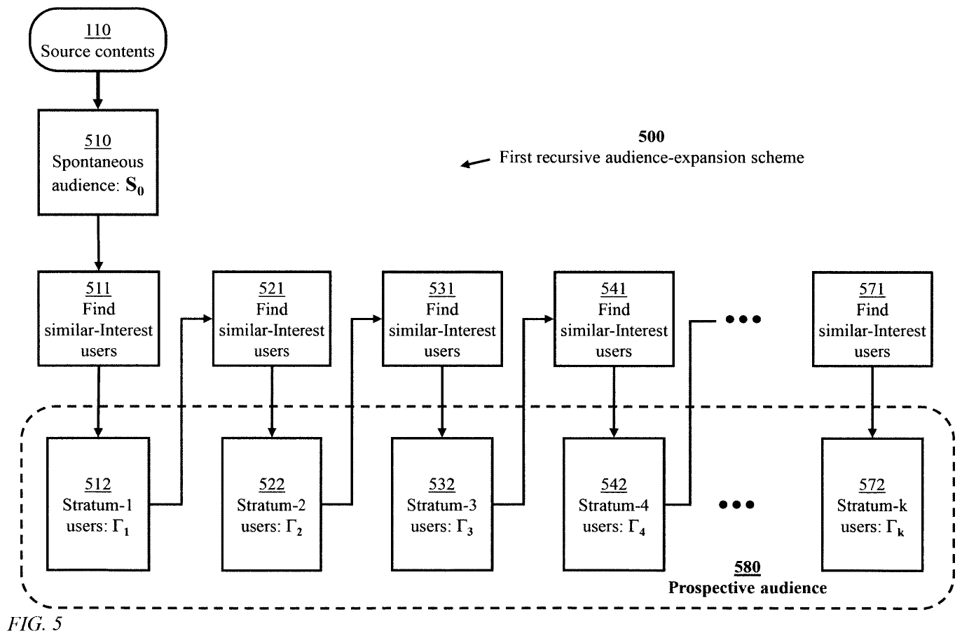

FIG. 4 is a diagram 400 visualizing recursive content-virality amplification. Starting with source contents 110, a set 430 of spontaneous audience, i.e., users 430 that accessed the source contents, is detected. A set of contents, other than the source contents, accessed by the spontaneous audience belonging to set 430 is identified; referenced as 440. The contents of set 440 are pruned to retain only relevant contents 441; unrelated contents 442 are eliminated. A set 450 of users that accessed the retained contents is detected. Set 450 is pruned to retain only related users 451; unrelated users 452 are eliminated. A set 460 of contents accessed by related users 451 is identified. The contents of set 460 are pruned to retain only relevant contents 461; unrelated contents 462 are eliminated. A set 470 of new users that accessed the retained contents is detected. Set 470 is pruned to retain only related users 471; unrelated users 472 are eliminated. The retained users 451 and 471 constitute prospective users with a high likelihood of accessing the source content.

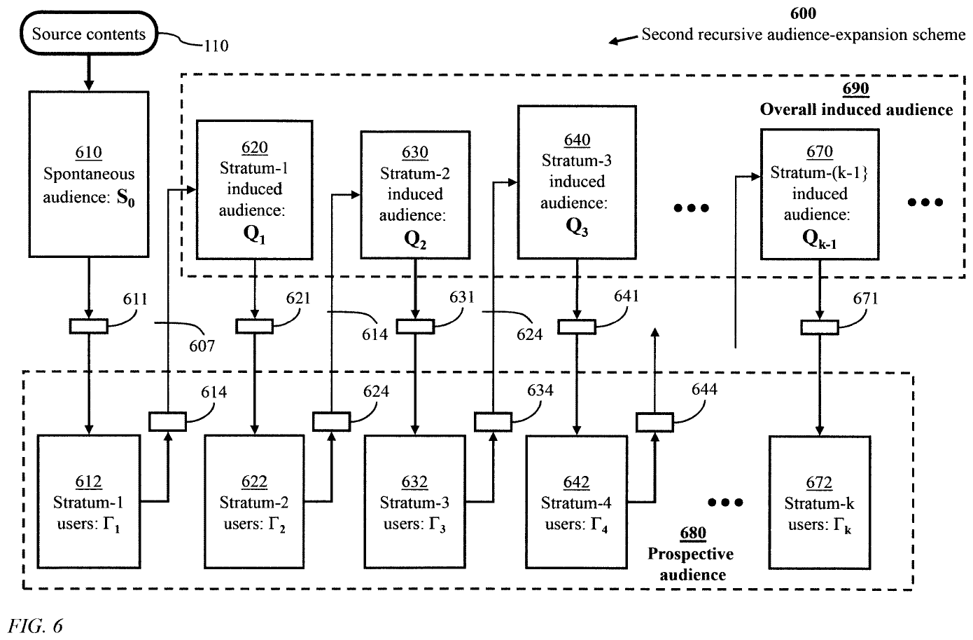

Several schemes of recursive audience expansion may be conceived. FIG. 5 illustrates a first recursive audience-expansion scheme 500. Starting with source contents 110 posted in a social medium, the engine of the present invention engages the social medium to detect a set 510, denoted S₀, of users attracted to the source contents. The attracted set 510 of users is referenced as “spontaneous audience”. The engine performs processes 511, 521, 531, 541, . . . , 571 to identify successive content-coupled sets of users.

Process 511 identifies users that are content-coupled to the spontaneous audience 510. A set 512 of users that are content coupled to spontaneous audience 510 is referenced as “stratum-1 users”. Process 521 identifies users that are content-coupled to stratum-1 users 512. A set 522 of users that are content coupled to stratum-1 users 512 is referenced as “stratum-2 users”. Process 531 identifies users that are content-coupled to stratum-2 users 522. A set 532 of users that are content coupled to stratum-2 users 522 is referenced as “stratum-3 users”. Process 541 identifies users that are content-coupled to stratum-3 users 532. A set 542 of users that are content coupled to stratum-3 users 532 is referenced as “stratum-4 users”.

Process 571 identifies users that are content-coupled to users of an immediately preceding stratum {stratum (k−1)}, k>4. A set 572 of users that are content coupled to stratum-(k−1) users is referenced as “stratum-k users”.

The set 580 of overall prospective users combines prospective users 512, 522, 532, 542, . . . , and 572. The engine communicates information relevant to the source contents 110 to the sets 580 of prospective users.

FIG. 6 illustrates a second recursive audience-expansion scheme 600. Starting with source contents 110 posted in a social medium, the engine of the present invention engages the social medium to detect a set 510, denoted S₀, of users attracted to the source contents. The attracted set 610 of users is referenced as “spontaneous audience”. The engine performs processes 611, 621, 631, 641, . . . , 671 to identify successive sets 612, 622, 632, 642, . . . , 672 of similar-interest users. The engine performs processes 614, 624, 634, 644, . . . , to successively communicate with the sets of similar-interest users and detect responsive subsets, 620, 630, 640, . . . 670, of sets 612, 622, 632, 642, . . . , 672 of similar-interest users that accessed the source contents. The responsive subsets are referenced as stratum-2 induced audience, stratum-3 induced audience, etc.

Process 611 identifies users that are content-coupled to the spontaneous audience 610. A set 612 of users that are content coupled to spontaneous audience 610 is referenced as “stratum-1 users”. Process 614 communicates with set 612 of stratum-1 users and detects stratum-1 induced audience 620—denoted Q.

Process 621 identifies users that are content-coupled to stratum-1 induced audience 620. A set 622 of users similar to stratum-1 induced audience 620 is referenced as “stratum-2 users”. Process 624 communicates with set 622 of stratum-2 users and detects stratum-2 induced audience 630, denoted Q₂, over a predefined interval of time.

Process 631 identifies users that are content-coupled to stratum-2 induced audience 630. A set 632 of users similar to stratum-2 induced audience 630 is referenced as “stratum-3 users”. Process 634 communicates with set 632 of stratum-3 users and detects stratum-3 induced audience 640, denoted Q₃, over a predefined interval of time.

Process 641 identifies users that are content-coupled to stratum-3 induced audience 640. A set 642 of users similar to stratum-3 induced audience 640 is referenced as “stratum-4” users. Process 644 communicates with set 642 of stratum-4 users and detects further induced audience (not illustrated). Continuing to stratum-k, k>4, induced audience Qₖ are detected.

Process 671 identifies users similar to induced users 670. A set 672 of users similar to induced audience 670 is referenced as “stratum-k” users.

The overall prospective audience 680 combines the sets of content-coupled users of stratum-1 to stratum-k. Overall induced audience 690 combines the sets 620, 630, . . . , 670, of induced audience.

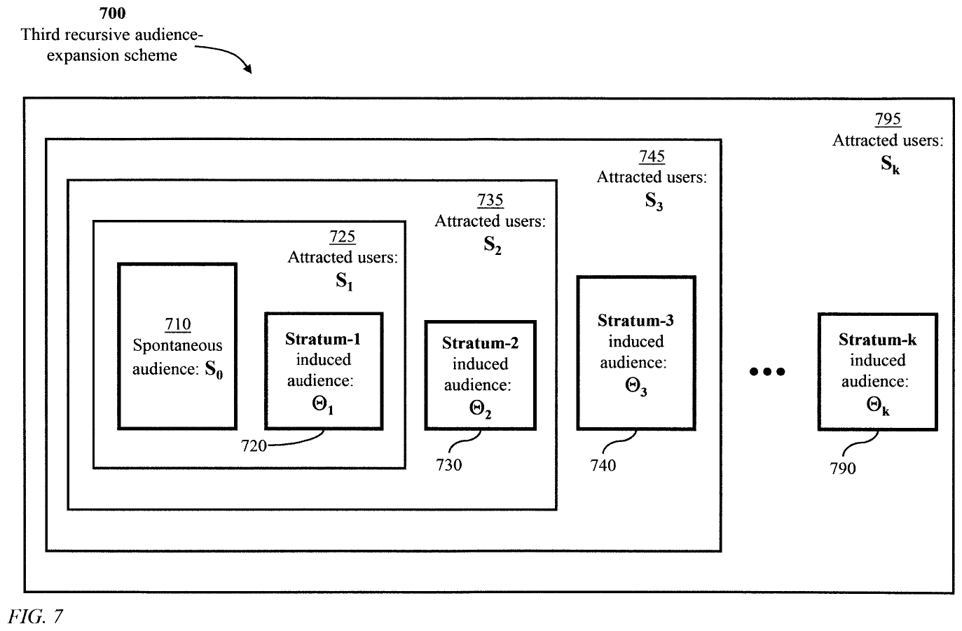

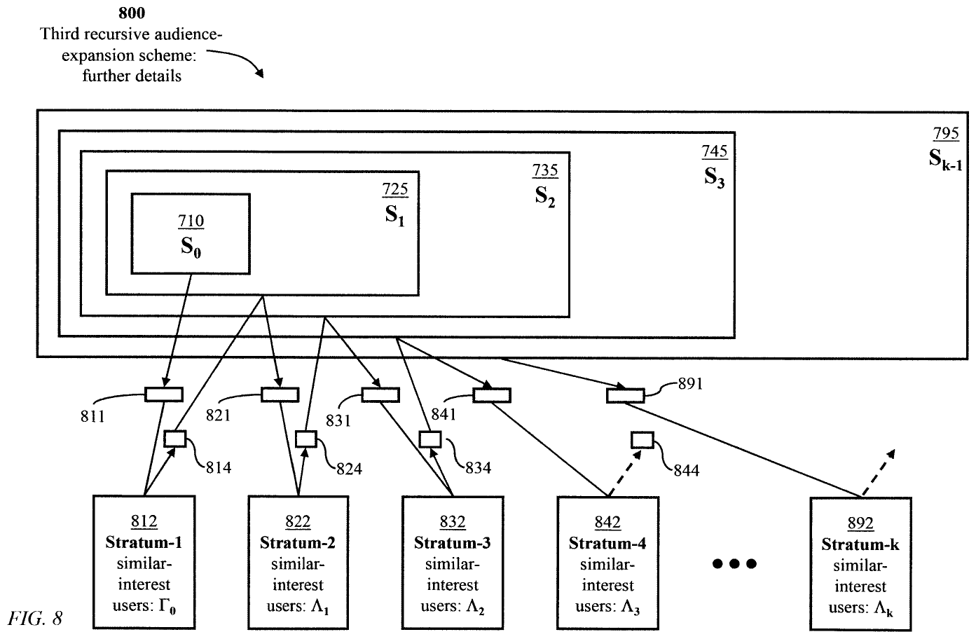

FIG. 7 illustrates a third recursive audience-expansion scheme 700 of spontaneous audience S₀. In a first recursion, information relevant to the source content is communicated to prospective audience that are content coupled to S₀. A set of induced audience 720, referenced as stratum-1 induced audience and denoted Θ₁, is detected. The induced audience Θ₁ is the audience gain of the first recursion. Set 725 of attracted users, referenced as stratum-1 attracted users and denoted S₁, comprises spontaneous audience S₀ and induced audience Θ₁; (S₁=S₀+Θ₂).

In a second recursion, information relevant to the source contents is communicated to prospective audience that are content coupled to S₁. A set 730 of induced audience, referenced as stratum-2 induced audience and denoted Θ₂, results from approaching users similar to Θ₁ in addition to natural increment of spontaneous audience and stratum-1 induced audience. The induced audience Θ₂ is the audience gain of the second recursion. Set 735 of attracted users, referenced as stratum-2 attracted users and denoted S₂, comprises spontaneous audience S₀ and cumulative induced audience; (S₂=S₁+Θ₁+Θ₂).

In a third recursion, information relevant to the source contents is communicated to prospective audience that are content coupled to S₂. A set 740 of induced audience, referenced as stratum-3 induced audience and denoted Θ₃, results from approaching users similar to Θ₂ in addition to natural increment of spontaneous audience and induced audience. The induced audience Θ₃ is the audience gain of the third recursion. Set 745 of attracted users, referenced as stratum-3 attracted users and denoted S₃, comprises spontaneous audience S₀ and cumulative induced audience; (S₃=S₀+Θ₁+Θ₂+Θ₃).

Continuing in the same fashion, a set 790 of induced audience, referenced as stratum-k induced audience and denoted Θₖ, k>3, results from approaching users similar to previously induced audience in addition to natural audience increment. Set 795 of attracted users, referenced as stratum-k attracted users and denoted Sₖ, comprises spontaneous audience S₀ and cumulative induced audience; (Sₖ=S₀+Θ₁+ . . . +Θₖ).

FIG. 8 illustrates further details 800 of the third recursive audience-expansion scheme. Process 811 identifies a set 812 of users that are content coupled to attracted users S₀. Process 814 communicates with users of set 812. Process 821 identifies a set 822 of users that are content coupled to attracted users S₁. Process 824 communicates with the users of set 822. Process 831 identifies a set 832 of users that are content coupled to attracted users S₂. Process 834 communicates with the users of set 832. Process 841 identifies a set 842 of users that are content coupled to attracted users S₃. Process 844 communicates with the users of set 842. Process 891 identifies a set 892 of users that are content coupled to attracted users Sₖ.

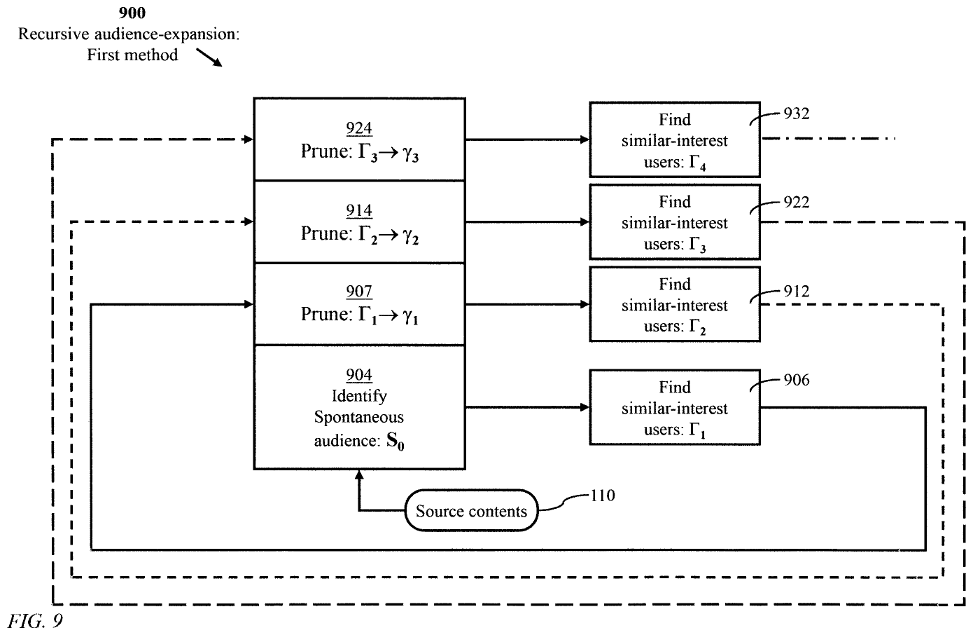

FIG. 9 illustrates details 900 of the first method 100 of recursive audience expansion. Process 904 identifies spontaneous audience S₀ of source contents 110. Process 906 finds a set Γ₁ of users that are content coupled to spontaneous users S₀. Process 907 prunes set Γ₁ to retain a set γ₁ of prospective audience content-coupled to spontaneous audience S₀. Process 912 finds a set Γ₂ of users that are content coupled to set γ₁ of prospective audience. Process 914 prunes set Γ₂ to retain a set γ₂ of prospective audience that are content coupled to set γ₁ of prospective audience. Process 922 finds a set Γ₃ of users that are content-coupled to set γ₂ of prospective audience. Process 924 prunes set Γ₃ to retain a set γ₃ of prospective audience that are content coupled to set γ₂ of prospective audience. Process 932 finds a set Γ₄ of users that are content coupled to set γ₃ of prospective audience.

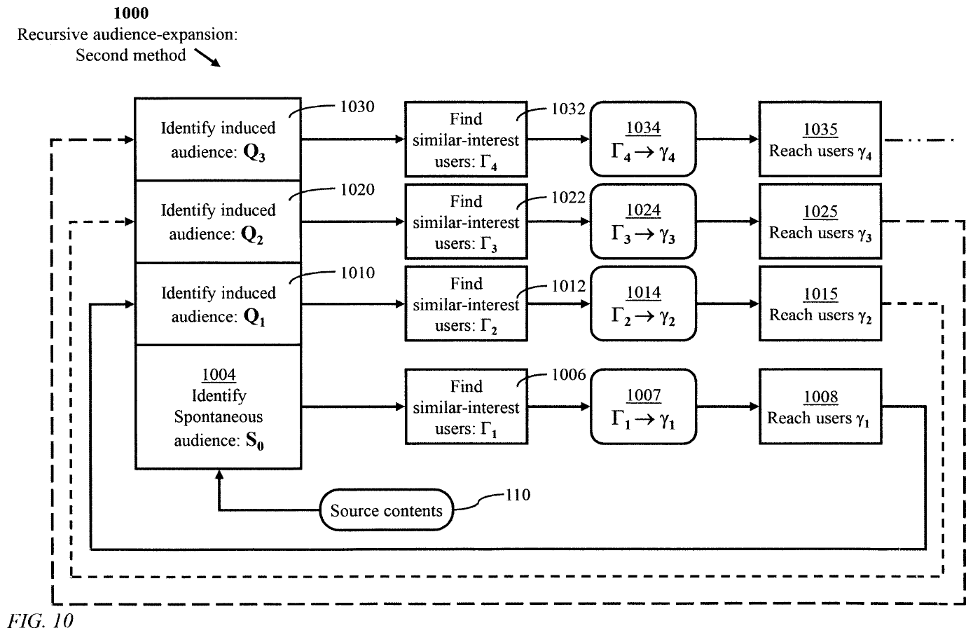

FIG. 10 illustrates details 1000 of the second method 200 of recursive audience-expansion scheme. Process 1004 identifies spontaneous audience S₀ of source contents 110. Process 1006 finds a set Γ₁ of users similar to spontaneous users S₀. Process 1007 prunes set Γ₁ to retain a set γ₁ of prospective audience similar to spontaneous audience S₀. Process 1008 communicates with set γ₁ of prospective audience.

Process 1010 identifies induced audience Q₁ resulting from process 1008. Process 1012 finds a set Γ₂ of users similar to induced audience Q₂. Process 1014 prunes set Γ₂ to retain a set γ₂ of prospective audience similar to induced audience Q₁. Process 1015 communicates with set γ₂ of prospective audience.

Process 1020 identifies induced audience Q₂ resulting from process 1015. Process 1022 finds a set Γ₃ of users similar to induced audience Q₂. Process 1024 prunes set Γ₃ to retain a set γ₃ of prospective audience similar to induced audience Q₂. Process 1025 communicates with set γ₃ of prospective audience.

Process 1030 identifies induced audience Q₃ resulting from process 1025. Process 1032 finds a set Γ₄ of users similar to induced audience Q₃. Process 1034 prunes set Γ₄ to retain a set γ₄ of prospective audience similar to induced audience Q₃. Process 1035 establishes communication with set γ₄ of prospective audience.

Processes 1007, 1014, 1024, and 1034 prune sets of similar-interest users to produce respective sets of prospective audience.

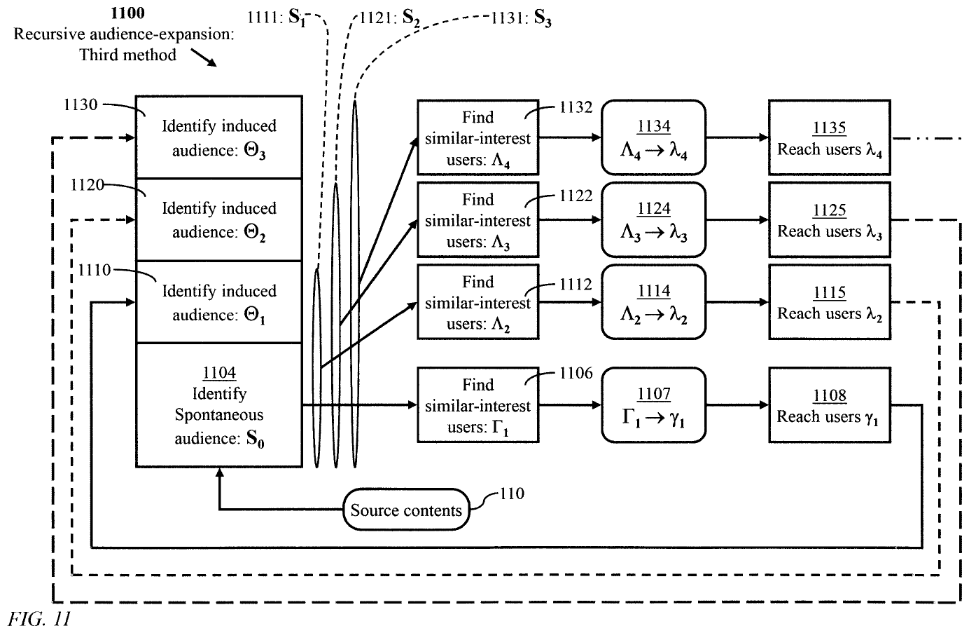

FIG. 11 illustrates details 1100 of the third method 300 of recursive audience-expansion scheme. Process 1104 identifies spontaneous audience S₀ of source contents 110. Process 1106 finds a set Γ₁ of users similar to spontaneous users S₁. Process 1107 prunes set Γ₁ to retain a set γ₁ of prospective audience similar to spontaneous audience S₀. Process 1108 communicates with set γ₁ of prospective audience.

Process 1110 identifies induced audience Θ₁ resulting from process 1108. Process 1112 finds a set Λ₂ of additional users similar to attracted users S₁; S₁=S₀+Θ₁. Process 1114 prunes set Λ₂ to retain a set λ₂ of additional prospective audience similar to attracted users S₁. Process 1115 distributes source-content information to set λ₂ of prospective audience

Process 1120 identifies induced audience Θ₂ resulting from process 1015. Process 1122 finds a set Λ₃ of additional users similar to attracted users S₂; S₂=S₀+Θ₁+Θ₂. Process 1124 prunes set Λ₃ to retain a set λ₃ of additional prospective audience similar to attracted users S₂. Process 1125 distributes source-content information to set ?₂ of prospective audience.

Process 1130 identifies induced audience Θ₃ resulting from process 1025. Process 1132 finds a set Λ₄ of additional users similar to attracted users S₃. S₃=S₀+Θ₁+Θ₂+Θ₃. Process 1134 prunes set Λ₄ to retain a set ?₄ of additional prospective audience similar to attracted users S₃. Process 1135 distributes source-content information to set λ₄ of prospective audience.

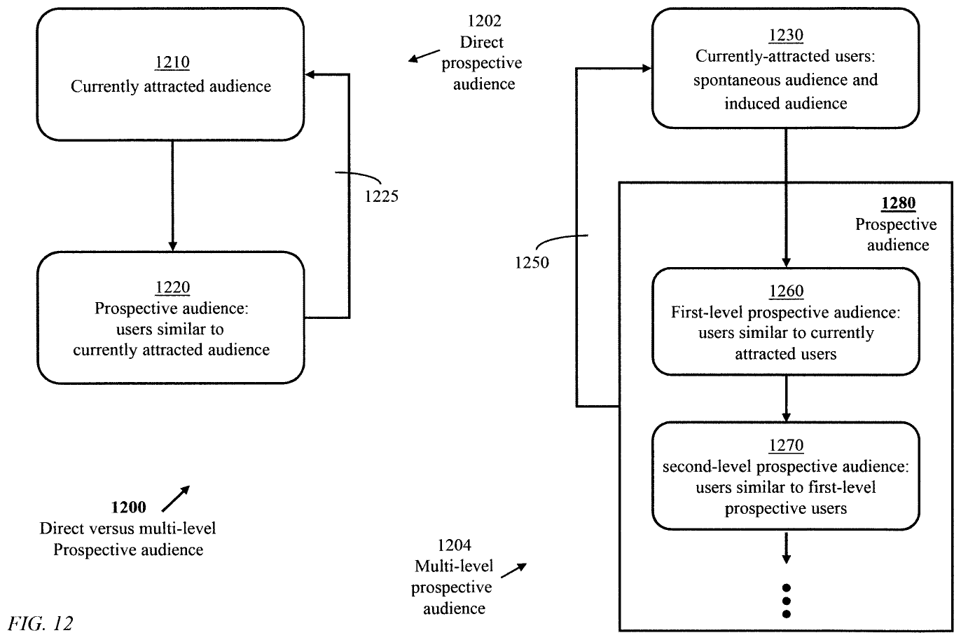

FIG. 12 illustrates alternative methods 1200 of generating prospective audience based on a known set of already attracted users.

Method 1202 determines a set 1220 of prospective audience based on direct content-coupling to a set of currently attracted users 1210. The engine distributes to the prospective audience information relevant to the source content, thus increasing the likelihood of attracting new users, herein referenced as “induced audience”. The set 1210 of currently attracted users may include spontaneous audience and induced audience. Upon detecting induced audience, the set of currently attracted users is updated, and a new content-coupled set of prospective audience (loop 1225) may be determined.

Method 1204 determines a set 1280 of prospective audience based on multi-level content coupling to currently attracted users 1230. A set 1260 of first stratum prospective audience is based on direct content-coupling to the set of currently attracted users 1230.

A set 1270 of second stratum prospective audience is based on content-coupling to set 1260 of first stratum prospective audience. The process may continue to successively determine higher levels of prospective audience. The engine distributes information relevant to the source content to the resulting total prospective audience 1280. Upon detecting induced audience, the set of currently attracted users is updated (loop 1250), and new content-coupled set of prospective audience may be determined.

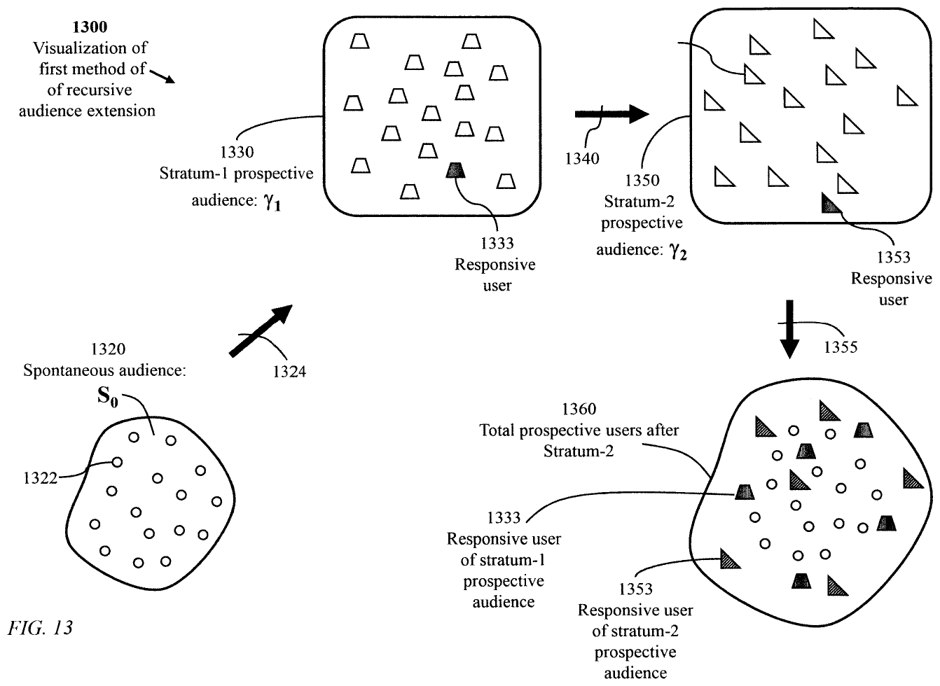

FIG. 13 presents visualization 1300 of the first method of recursive audience expansion starting with a set 1320 of spontaneous audience, denoted S₀, which comprises users 1322 attracted to the source contents. A process 1324 determines a set 1330 of stratum-1 prospective audience based on content-coupling to the set 1320 of spontaneous audience.

A process 1340 determines a set 1350 of stratum-2 prospective audience based on content-coupling to the set 1330 of stratum-1 prospective audience.

The engine distributes information relevant to the source content to the resulting stratum-1 and stratum-2 prospective audience. The illustrated set 1360 of attracted users includes the set 1320 of spontaneous audience, responsive stratum-1 prospective audience 1333, responsive stratum-2 prospective audience 1353. Set 1360 of attracted users may also include additional spontaneous audience that accessed the source contents without prompting.

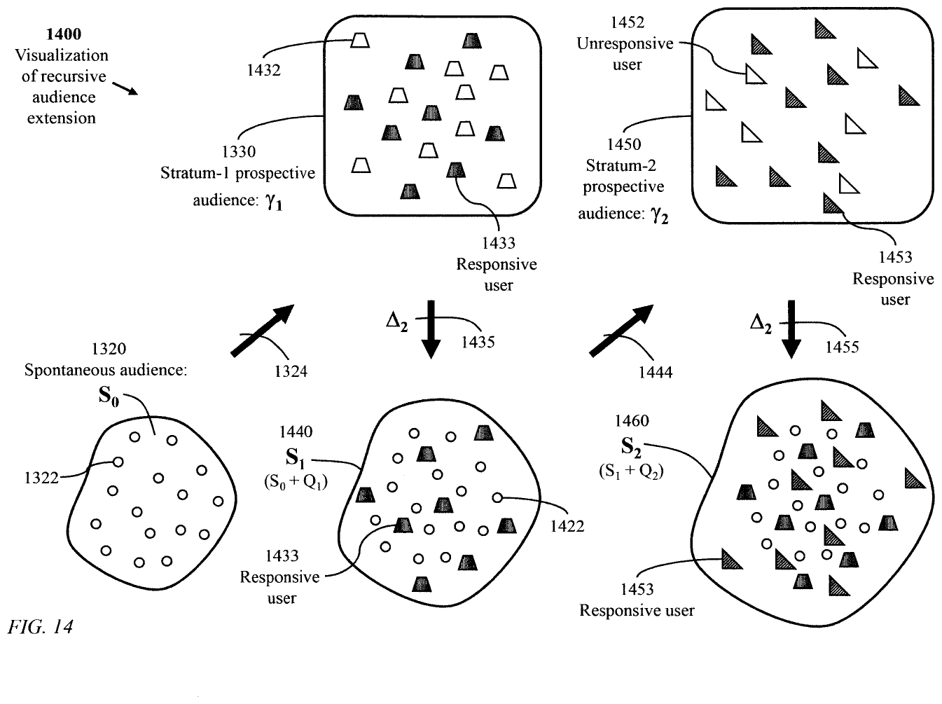

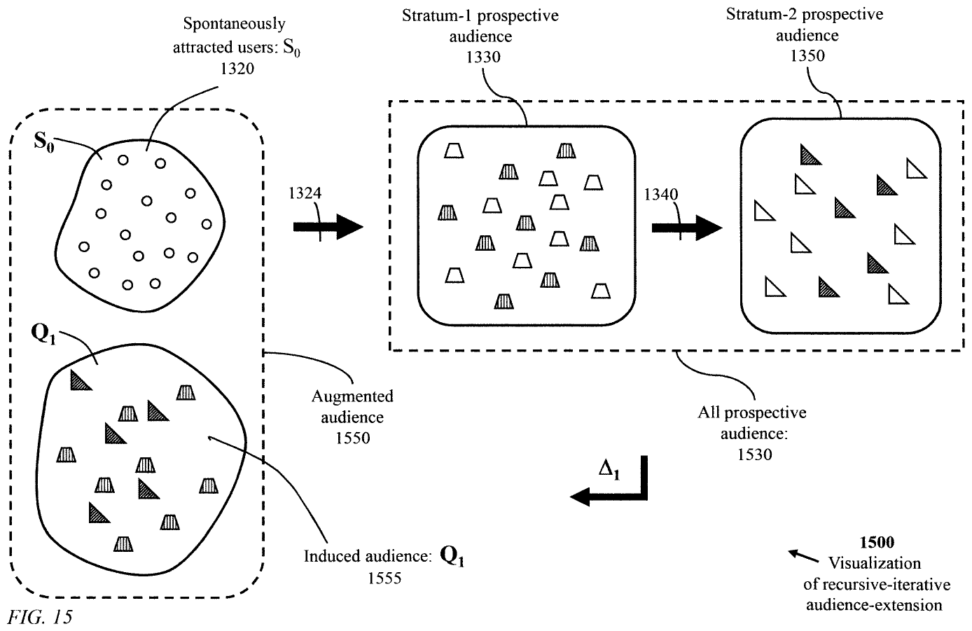

FIG. 14 presents visualization 1400 of the second method of recursive audience extension starting with a set 1320 of spontaneous audience, denoted S₀, which comprises users 1322 attracted to the source contents. A process 1324 determines a set 1330 of stratum-1 prospective audience based on content-coupling to the set 1320 of spontaneous audience.

Process 1435 identifies stratum-1 induced audience of stratum-1 prospective audience (after an artificial delay Δ₂). As indicated, set 1330 of stratum-1 prospective audience includes unresponsive users 1432 and responsive users 1433. Set 1440 of already attracted users includes the set 1320 of spontaneous audience 1322 and stratum-1 induced audience (responsive users 1433).

Process 1444 identifies a set 1450 of stratum-2 prospective audience based on content-coupling to stratum-1 responsive users 1433. As indicated, set 1450 of stratum-2 prospective audience includes unresponsive users 1452 and responsive users 1453.

Process 1455 identifies stratum-2 induced audience of stratum-2 prospective 1450 (after an artificial delay Δ₂). Set 1460 of already attracted users includes the spontaneous audience 1322, stratum-1 induced audience 1433, and stratum-2 induced audience 1453.

FIG. 15 presents visualization 1500 of recursive-iterative audience expansion. Starting with a set 1320 of spontaneous audience, denoted S₀, which comprises users 1322 attracted to the source contents. A process 1324 determines a set 1330 of stratum-1 prospective audience based on content-coupling to the set 1320 of spontaneous audience. A process 1340 determines a set 1350 of stratum-2 prospective audience based on content-coupling to the set 1330 of stratum-1 prospective audience. The engine distributes information relevant to the source content to the combined stratum-1 and stratum-2 prospective audience 1530 and detects a set 1555 of induced audience which includes responsive stratum-1 prospective audience and responsive stratum-2 prospective audience.

Augmented audience set 1550 includes the set 1320 of spontaneous audience, set 1555 of induced audience responsive stratum-1, and may also include additional spontaneous audience that accessed the source contents without prompting.

The engine then repeats the above processes starting with the set 1550 of augmented audience instead of the set 1320 of spontaneous audience.

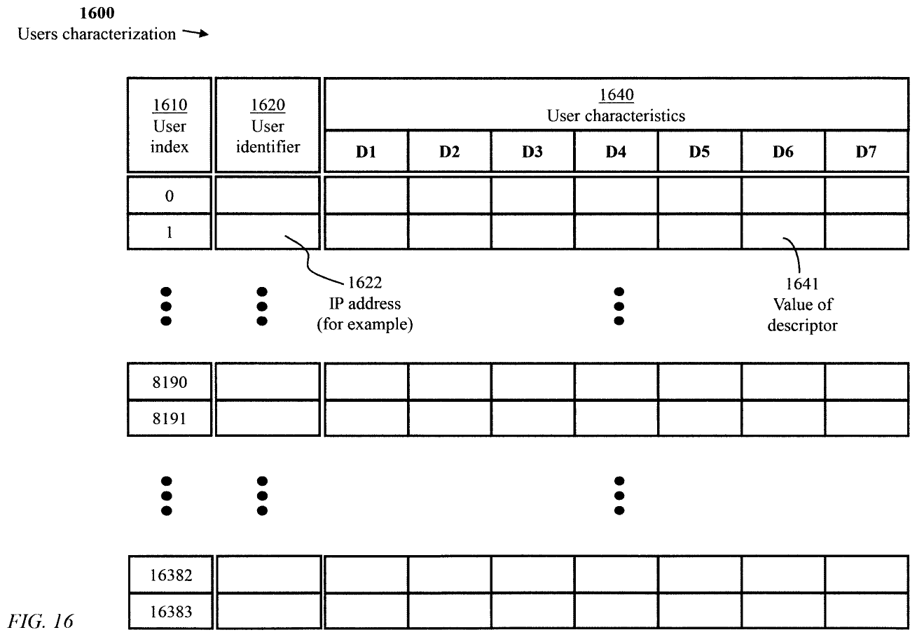

FIG. 16 illustrates an exemplary set 1600 of user-characterization data comprising a record for each user of a plurality of users. The exemplary set 1600 comprises 16384 records indexed as 0 to 16383. Each record indicates a user index 1610, a respective user identifier 1620, and descriptor values 1641 of a set 1640 of seven user descriptors labeled D1 to D7. A user identifier may be an IP address 1622. The descriptors may be based on specific traits of a user.

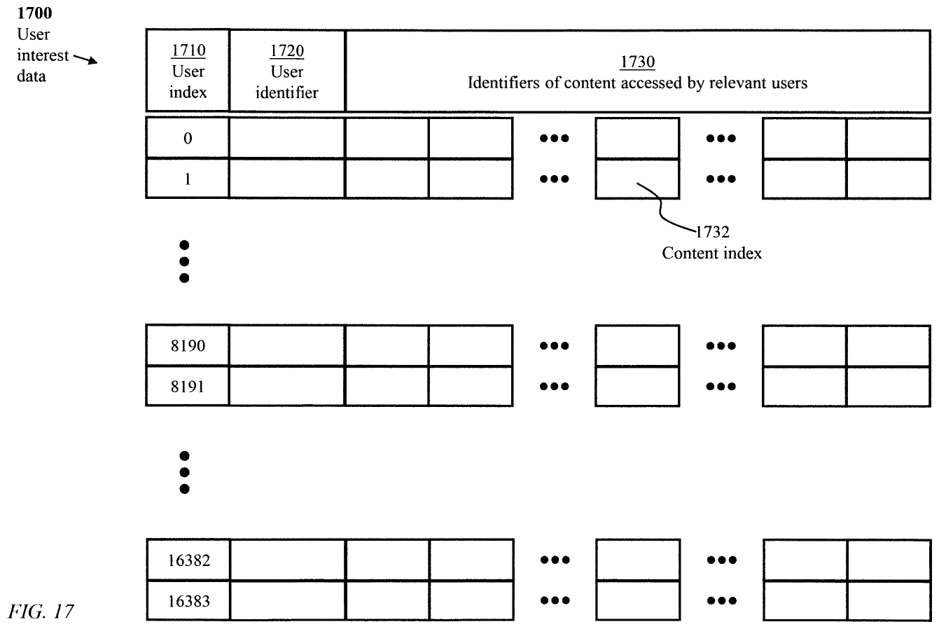

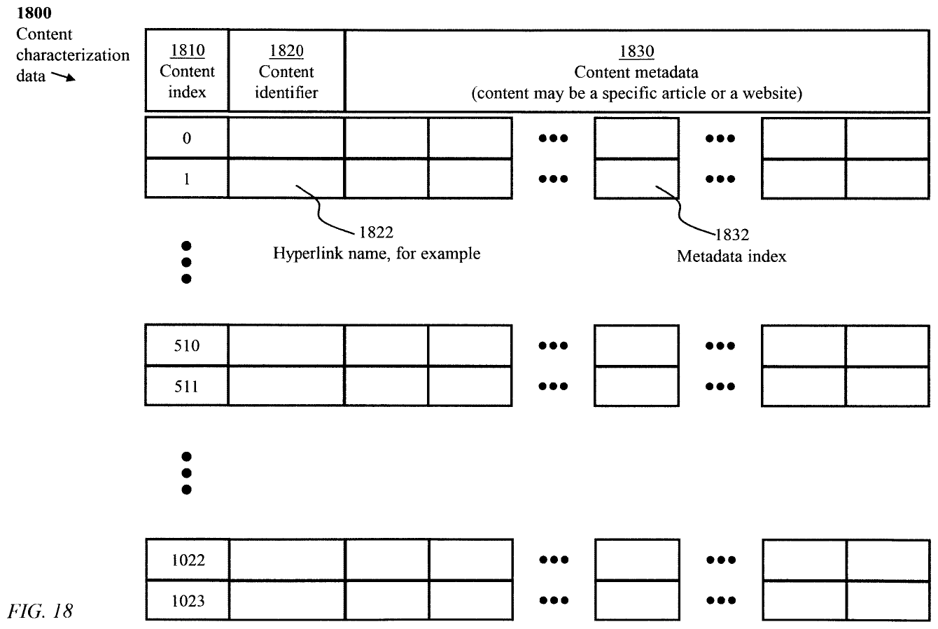

FIG. 17 illustrates an exemplary set 1700 of users' content-access data comprising a record for each user of the plurality of users considered in set 1600 of user-characterization data. The exemplary set 1700 comprises 16384 records indexed as 0 to 16383. Each record indicates a user index 1610 and a set 1730 of identifiers of contents accessed by the user. An identifier of a context may be based on a set of semantics or an index 1732 of a content in a directory of contents (not illustrated).

FIG. 18 illustrates an exemplary collection 1800 of content-characterization data comprising a record for each content of a plurality of contents. The exemplary collection 1800 comprises 1024 records indexed as 0 to 1023. Each content record indicates a content index 1810, a content identifier 1820, and content metadata 1830. A content identifier may be a hyperlink name 1822, and the content metadata may be a metadata-index 1832.

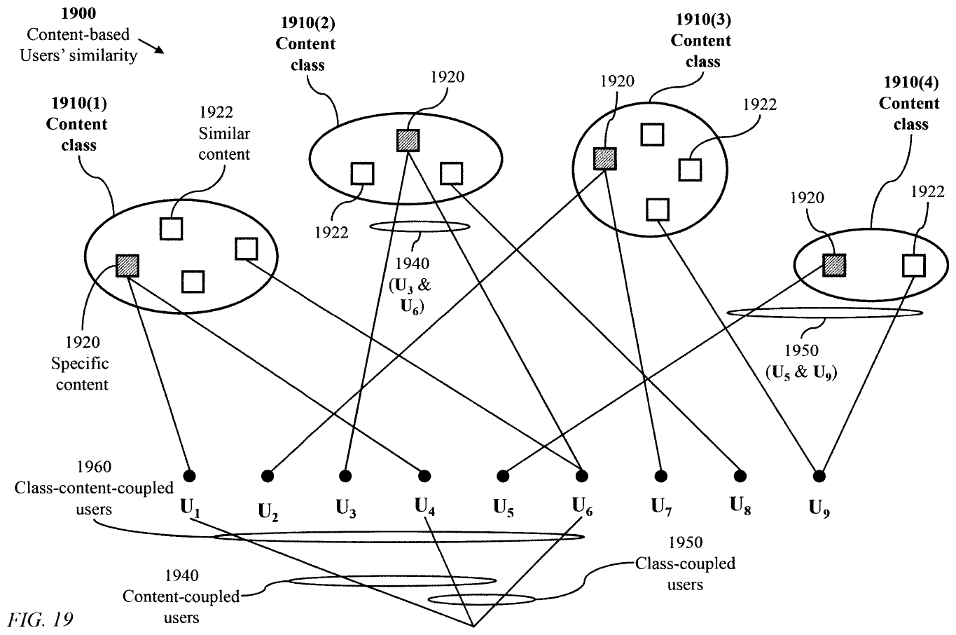

FIG. 19 illustrates a set 1900 of content-coupled users, class-coupled users, and class-content-coupled users. A content class 1910 comprises a respective specific content 1920 and a number of contents 1922 considered similar to the specific content 1920. FIG. 19 illustrates nine users, labeled U1 to U9, and four content-classes 1910(1), 1910(2), 1910(3), and 1910(4).

Content-coupled users are defined as users commonly accessing a specific content. Class-coupled users are defined as users that accessed different contents of a specific class of contents. Class-content-coupled users are defined as users that accessed any content of a specific class. A class-content set of users is the union of a set of content-coupled users and a set of class-coupled users. Users U1 and U4 access a specific content 1920 of content class 1910 and are, therefore, content-coupled users 1940. Users U4 accessed content 1920 of content class 1910(1) and user U6 accessed content 1922 of content class 1910(1). U4 and U6 are therefore class-coupled users 1950. Users U1, U4, and U6 access different contents of a single class 1910(1) and are, therefore, Class-content-coupled users 1960.

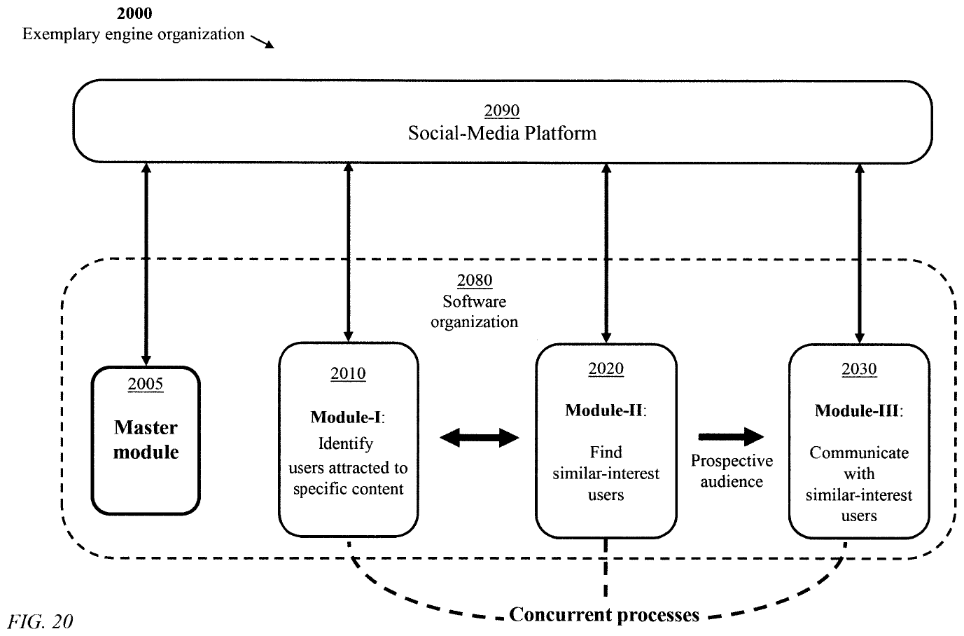

FIG. 20 illustrates an exemplary engine 2000 for content-virality amplification. The engine is communicatively coupled to a social-media platform 2090 and comprises at least one hardware processor (not illustrated in FIG. 20) executing software instructions 2080 organized into a Master module 2005 and independent modules labeled Module-I, Module-II, and Module-III.

Module-I, 2010, comprises processor-readable instructions configured to identify users attracted to specific contents. Module-II, 2020, comprises processor-readable instructions configured to find contents accessed by specific users. Module-III, 2030, comprises processor-readable instructions configured to communicate with prospective users.

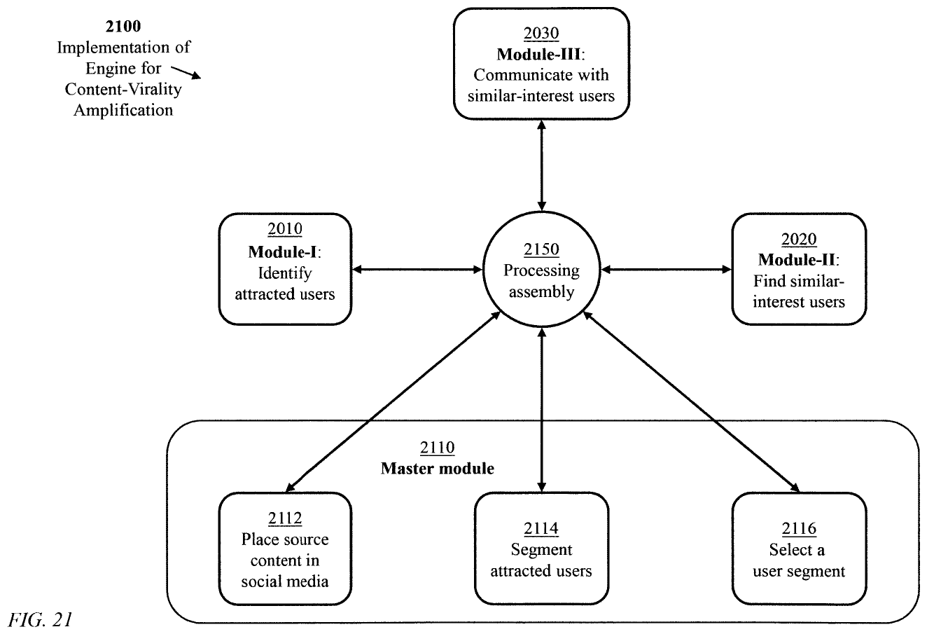

FIG. 21 illustrates an exemplary hardware organization 2100 of engine 2000. A processing assembly 2150, comprising multiple hardware processors, executes software instructions organized into a Master module 2010 and instruction sets 2080 organized into independent modules Module-I, Module-II, and Module-III that may be activated concurrently. The Master module 2110 comprises instruction set 2112 for placing source content in selected social media storage devices, an instruction set 2114 for segmenting a set of attracted users (spontaneous audience and induced audience), and an instruction set 2116 for selecting a preferred subset of the set of attracted users.

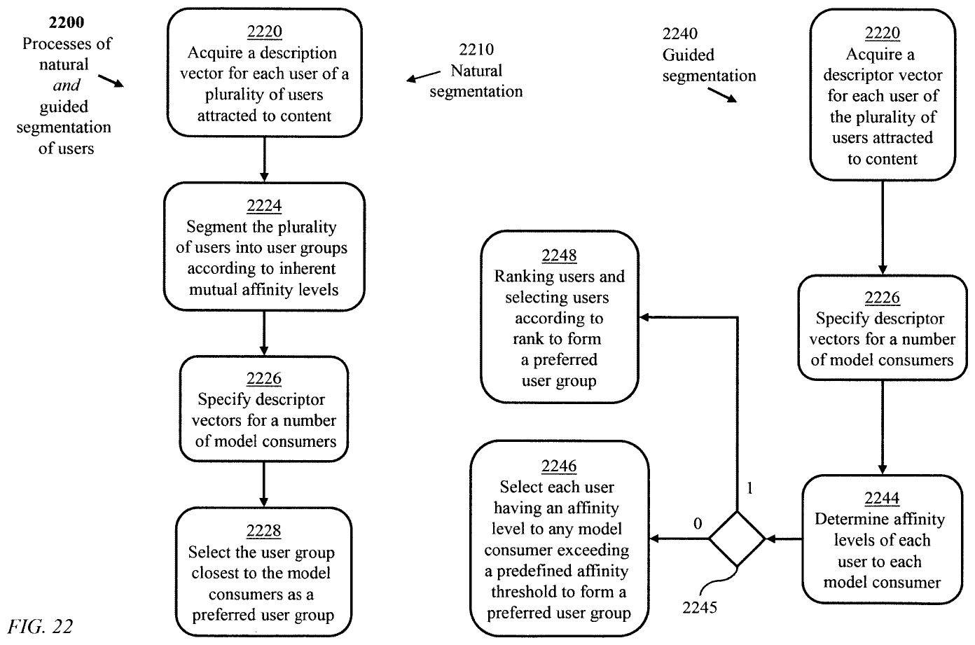

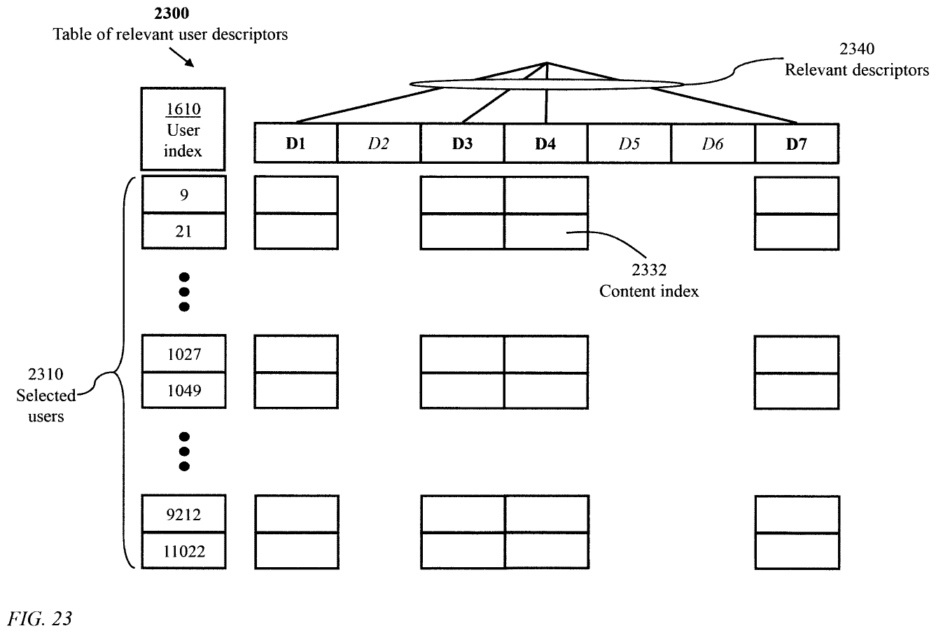

FIG. 22 illustrates processes 2200 of user-group selection according to natural-segmentation procedure 2210 and user-group selection according to a guided-segmentation procedure 2240 for use in the engine of FIG. 20 and FIG. 21.

### Natural Segmentation

The natural-segmentation procedure applies any of conventional object-segmentation methods. Process 2220 acquires a description vector of each user of a plurality of users attracted to specific contents. Process 2224 segments the plurality of attracted users into user groups according to inherent mutual-affinity levels. Process 2226 acquires descriptor vectors for a number of model consumers and process 2228 selects the user group closest to the model consumers as a preferred user group.

### Guided Segmentation

The guided-segmentation procedure performs processes of:
(i) Acquiring description vector of each user of a plurality of users attracted to specific contents (process 2220);
(ii) Acquiring descriptor vectors for a number of model consumers (Process 2226);
(iii) Determining affinity levels of each user to each model consumer (process 2244); and
(iv) Selecting target users (process 2245).

The target users may include:
users each having an affinity level exceeding a predefined affinity threshold to form a preferred user group (process 2246); or
users selected according to rank, where the users are ranking according to affinity levels to the model consumers (process 2248).

FIG. 23 illustrates a table 2300 of a set 2310 of related users and corresponding selected descriptors 2340 extracted from the set 1600 of user-characterization data of FIG. 16. The set 2310 of selected users is determined according to either of the natural segmentation method 2210 or the guided segmentation method 2240.

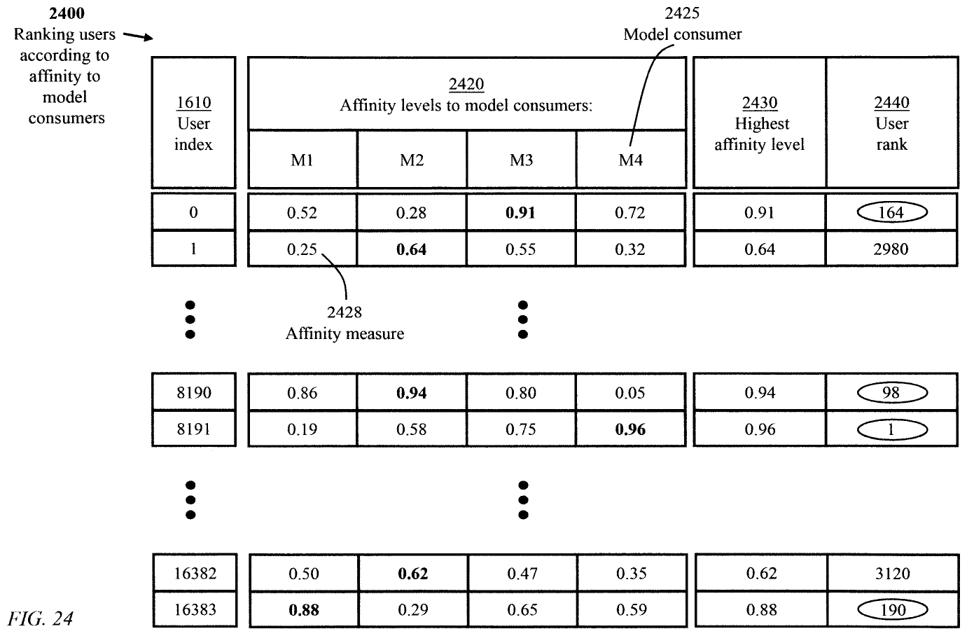

FIG. 24 illustrates a table 2400 of ranked relevant users based on affinity levels 2420 to individual model consumers. Four model consumers 2425 labeled M1, M2, M3, and M4 are considered. The affinity level 2428 of each user to each model consumer is determined using conventional methods. The affinity level of a user to the set of model consumers may be defined as a function of the individual affinity levels 2428 of the user to the model consumers. In one implementation, the arithmetic mean value of the affinity levels 2428 may be used as indicative of the affinity level of the user to the set of model consumers. In a preferred implementation, the highest affinity level 2430 of a user to the individual model consumers may be used.

A user rank 2440 may be determined for each user based on set-affinity levels. As illustrated, the user of index 8191 with an affinity index to the set of model consumers of 0.96 is of user-rank 1, the user of index 0 with an affinity index to the set of model consumers of 0.91 is ranked at 164.

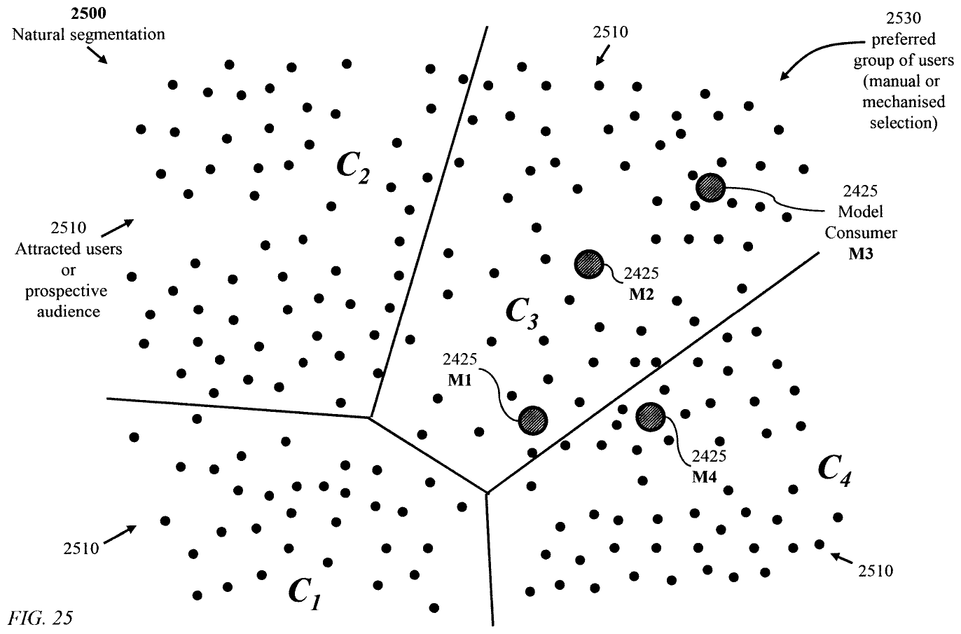

FIG. 25 illustrates natural segmentation 2500 of users 2510 into four clusters, labeled C1, C2, C3, and C4, where each user is characterized by a descriptor vector of only two descriptors. In general, a user may be characterized by a descriptor vector of a larger dimension. Four model consumers 2425, labeled M1, M2, M3, and M4, each characterized according to the same description vector are indicated. None of the model consumers is embedded in cluster C1 or cluster C2. Model consumers M1, M2, and M3 are embedded within cluster C3, model consumer M4 is embedded in cluster C4. The users belonging to cluster C3 are the preferred group 2530 of users to approach for audience expansion.

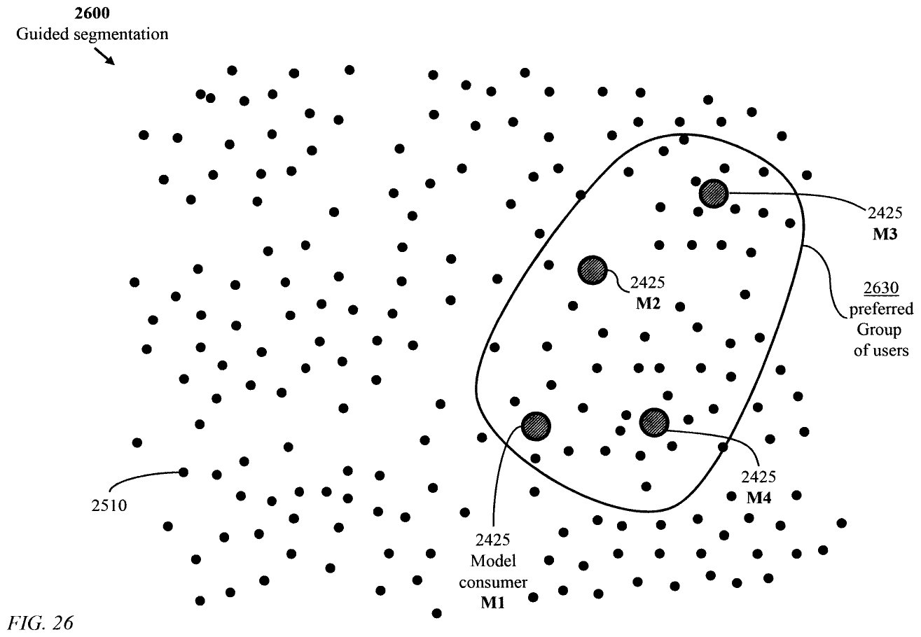

FIG. 26 illustrates guided segmentation 2600 of users 2510 where a set of users is selected according to affinity to the set of model consumers. A preferred group 2630 of users is selected according to affinity to the model consumers M1, M2, M3, and M4. For each user 2510, a measure of affinity to the set of model consumers is determined. According to one embodiment, each user 2510 having an affinity measure exceeding a predefined threshold is allocated to the preferred group. According to another embodiment, the users are ranked as illustrated in FIG. 24 and the preferred group comprises a predefined number of highest ranked users; for examples users of rank 1 to 100.

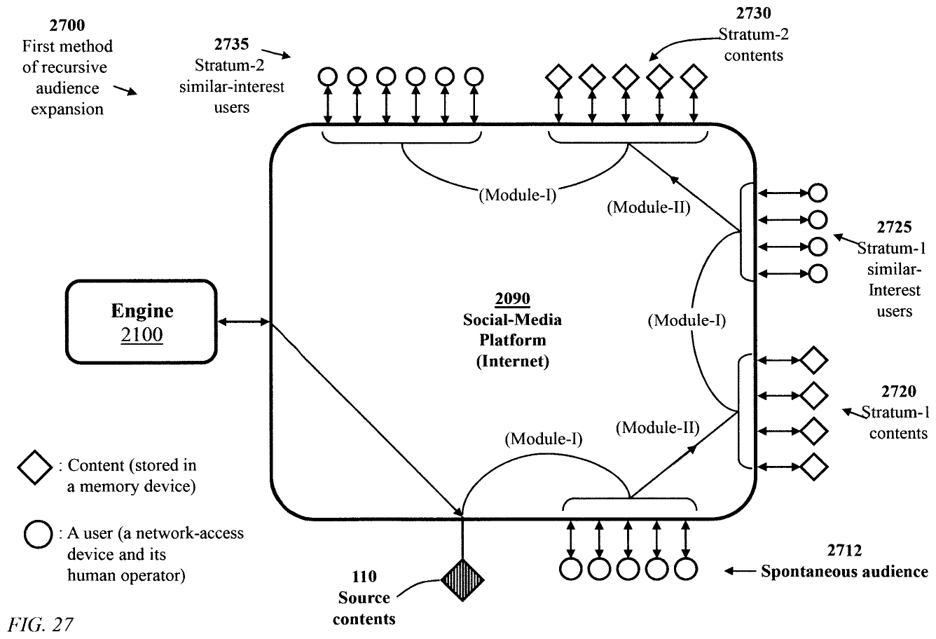

FIG. 27 details a recursive audience expansion procedure 2700 implemented at the engine 2100 of FIG. 21 based on the first recursive audience expansion scheme illustrated in FIG. 5. The procedure is described below.
(i) Starting with source contents 110, a set of spontaneous audience 2712 is determined by activating Module-I, 2010.
(ii) A set 2720 of stratum-1 contents, defined as contents—other than the source contents—accessed by the spontaneous audience is then determined by activating Module-II, 2020.
(iii) A set 2725 of stratum-1 similar-interest users, defined as users that are content-coupled, through stratum-1 contents, to the spontaneous audience is determined by activating Module-I, 2010.
(iv) A set 2730 of stratum-2 contents, defined as contents—other than stratum-1 contents—accessed by stratum-1 similar-interest users is then determined by activating Module-II, 2020.
(v) A set 2735 of stratum-2 similar-interest users, defined as users that are content-coupled, through stratum-2 contents, to stratum-1 similar-interest users is determined by activating Module-I, 2010.

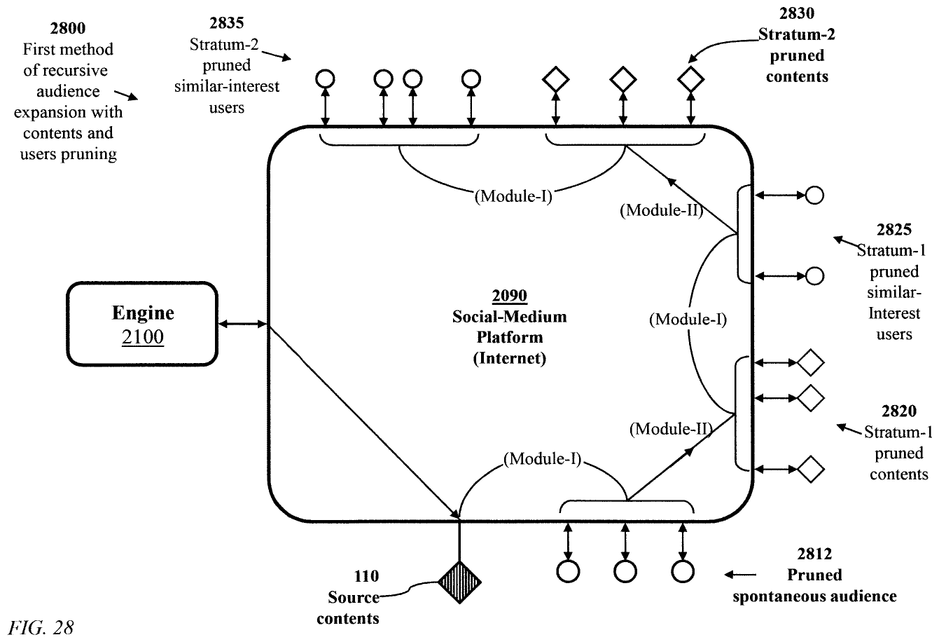

FIG. 28 illustrates a recursive audience expansion process 2800 implemented at engine 2100 of FIG. 21 with pruned contents and pruned users employing the first recursive audience expansion scheme illustrated in FIG. 5.
(a) Starting with source contents 110, a set of spontaneous audience 2712 is determined by activating Module-I, 2010 from which a set 2812 of pruned spontaneous audience is derived.
(b) A set of stratum-1 contents, defined as contents—other than the source contents—accessed by the pruned spontaneous audience is then determined by activating Module-II, 2020; the set is pruned to produce a set of pruned stratum-1 contents 2820.
(c) A set of stratum-1 similar-interest users, defined as users that are content-coupled, through pruned stratum-1 contents, to the pruned spontaneous audience is determined by activating Module-I, 2010; a set 2825 of pruned stratum-1 similar-interest users is derived by eliminating users of specific traits.
(d) A set of stratum-2 contents, defined as contents—other than stratum-1 contents-accessed by pruned stratum-1 similar-interest users is then determined by activating Module-II, 2020; the set is pruned to produce a set 2830 of pruned stratum-1 contents.
(e) A set of stratum-2 similar-interest users, defined as users that are content-coupled, through pruned stratum-2 contents, to pruned stratum-1 similar-interest users is determined by activating Module-I, 2010; the set is pruned to produce set 2835 of pruned stratum-2 similar-interest users.

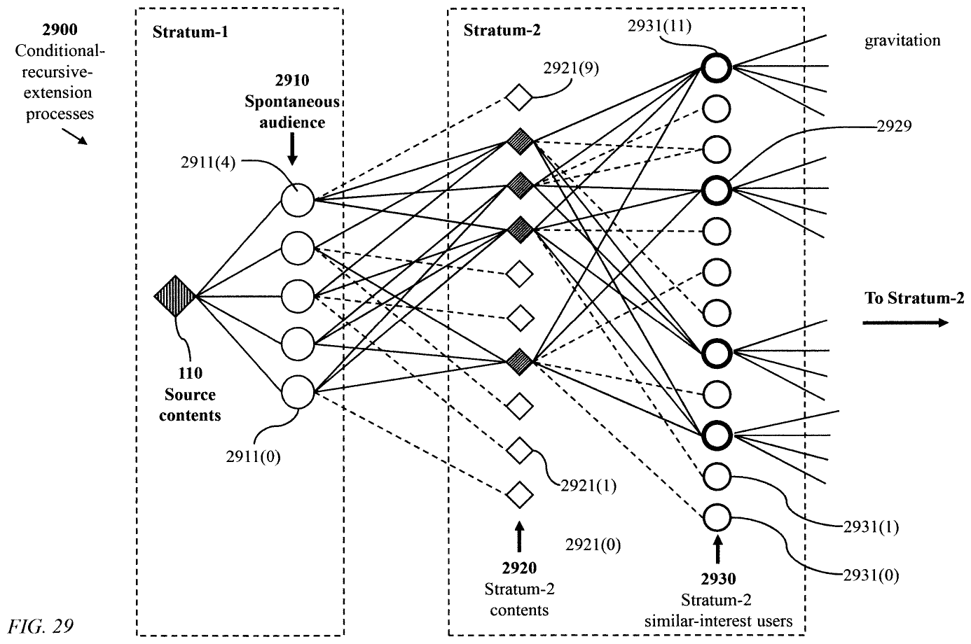

FIG. 29 illustrates a conditional recursive-expansion process 2900 where content-coupled sets of users are selected to meet requisite content gravitation levels and user-activity levels.

Starting with source contents 110 posted in a social medium, a set 2910 of spontaneous audience (spontaneously attracted users) is determined by activating Module-I, 2010 as described above with reference to FIG. 27.

Module-II is activated to track individual attracted user 2911 of the spontaneous audience to determine accessed contents, other than the source contents 110. The union of contents accessed by individual attracted users 2911 form a set 2920 of stratum-1 contents 2921; the number of stratum-1 contents in the example of FIG. 29 is 10. Module-II determines gravitation scores of individual stratum-1 contents and retains only contents 2921 having a gravitation score exceeding a predefined threshold. By definition, a gravitation score of a specific content is a number of users that accessed the specific content.

The gravitation scores of the ten stratum-1 contents 2911(0) to 2921(9) are 1, 1, 1, 3. 1, 1, 4, 3, 3, and 1, respectively. With a gravitation threshold of 2, for example, only four stratum-1 contents are retained.

Module-I is activated again to find users 2931, other than the spontaneous audience and labeled stratum-1 users, that accessed the retained contents of the set of stratum-1 contents. In the example of FIG. 29, a set 2930 of stratum-1 users comprises 12 users 2931(0) to 2931(11). Module-I determines user-activity score for each stratum-1 user 2931 and retains only stratum-1 users having a score exceeding a predefined user-activity threshold. By definition, an activity score of a user is a number of relevant contents that the user accessed. The user-activity scores of the 12 stratum-1 users 2931(0) to 2931(11) are 1, 1, 3, 1, 3, 1, 1, 1, 3, 2, 1, and 4. With a user-activity threshold of 2, for example, only four stratum-1 users are retained.

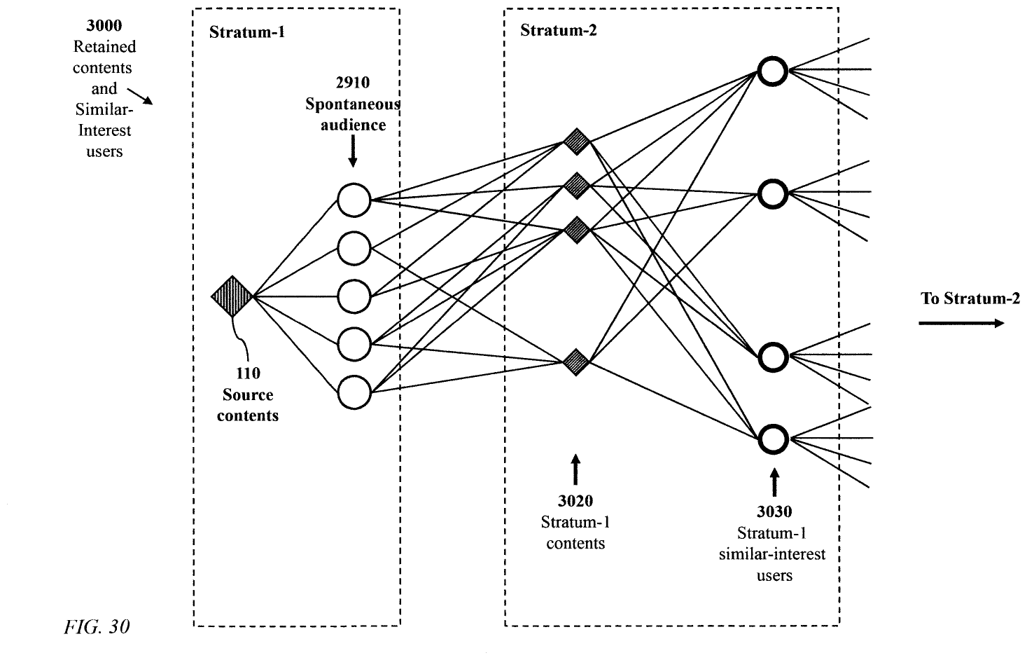

FIG. 30 illustrates results 3000 of the conditional recursive-expansion process eliminating low-gravitation contents and low-activity users for clarity. Set 3020 of stratum-1 contents comprises only relevant stratum-1 contents and set 3030 of stratum-1 prospective audience comprises only stratum-1 users of interest.

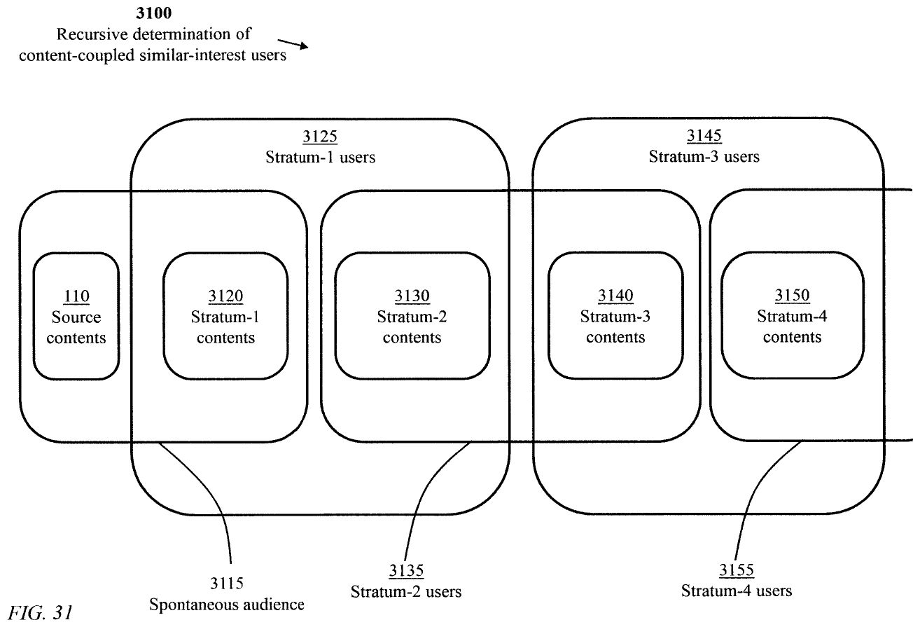

FIG. 31 illustrates a scheme 3100 of recursive determination of similar-interest users by successive activation of Module-I and Module II. Starting with source contents 110, Module-I is activated to determine set 3115 of spontaneous audience.

Module-II is activated to determine set 3120 of stratum-1 contents accessed by the set 3115 of spontaneous audience. Module-I is activated to determine set 3125 of stratum-1 similar-interest users, which are users that accessed set 3120 of stratum-1 contents.

Module-II is activated to determine set 3130 of stratum-2 contents accessed by the set 3125 of stratum-1 similar-interest users. Module-I is activated to determine set 3135 of stratum-2 similar-interest users, which are users that accessed set 3130 of stratum-2 contents.

Module-II is activated to determine set 3140 of stratum-3 contents accessed by the set 3135 of stratum-2 similar-interest users. Module-I is activated to determine set 3145 of stratum-3 similar-interest users, which are users that accessed set 3140 of stratum-3 contents.

Module-II is activated to determine set 3150 of stratum-4 contents accessed by the set 3135 of stratum-3 similar-interest users. Module-I is activated to determine set 3155 of stratum-4 similar-interest users, which are users that accessed set 3150 of stratum-4 contents.

Thus:
set 3125 of stratum-1 users is content coupled to set 3115 of spontaneous audience through set 3120 of stratum-1 contents;
set 3135 of stratum-2 users is content coupled to set 3125 of stratum-1 users through set 3130 of stratum-2 contents;
set 3145 of stratum-3 users is content coupled to set 3135 of stratum-2 users through set 3140 of stratum-3 contents; and
set 3155 of stratum-4 users is content coupled to set 3145 of stratum-3 users through set 3150 of stratum-4 contents.
Stratum-1, stratum-2, stratum-3, and stratum-4 users constitute the audience gain.

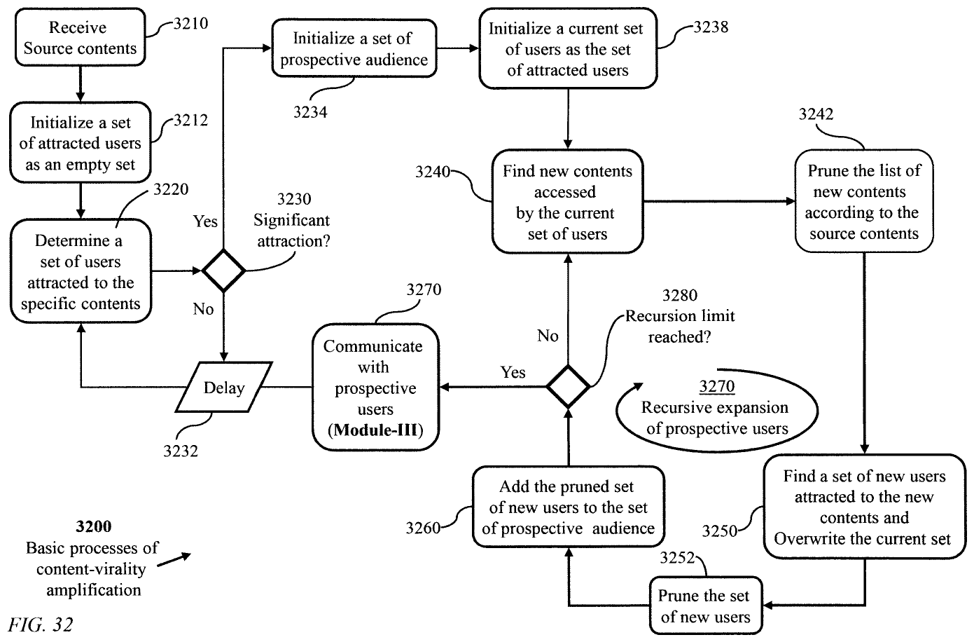

FIG. 32 is a flow chart of the basic processes 3200 of the engine 2100 of FIG. 21. Upon receiving source content (process 3210), a set of attracted users is initialized as an empty set (process 3212). Module-I is activated to determine a “set of attracted users”, which comprises users attracted to the source content (process 3220).

Process 3230 determines whether the set of attracted users contains a significant number of attracted users. If the number of attracted users exceeds a predefine gravitation threshold, process 3230 directs the set of attracted users to process 3234. Otherwise, process 3232 revisits process 3220 after an artificial delay of a predefined time interval.

Process 3234 initializes a “set of prospective audience” and process 3238 initializes a “current set of users” as the set of attracted users.

Process 3240 activates module-II to find a set of new contents accessed by the current set of users. Process 3242 prunes the set of new contents according to similarity to the source content, retaining contents of high similarity to the source content.

Process 3250 activate module-I to find a set of new users attracted to the new contents. The set of new users overwrites the current set of users. Process 3252 prunes the set of new users. Process 3260 adds the pruned set of new users to the set of prospective audience. Process 3280 counts recursions 3270 and determines whether a predefined number of recursions has been reached. A recursion 3270 traversing processes 3240, 3242, 3250, 3252, and 3260.

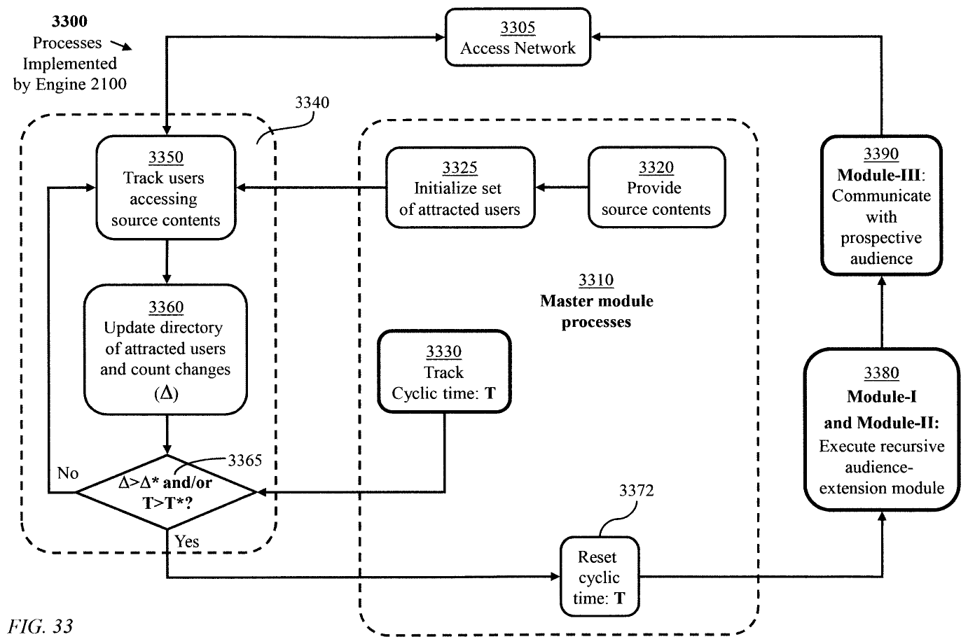

FIG. 33 is a flow chart of processes 3300 performed by engine 2100 of FIG. 21 which executes instructions of the master module, module-I, module-II, and module-III of FIG. 20. Process 3305 accesses a network to engage social media and exhibit source contents. Processes 3310 of the Master module, include posting source contents (process 3320), initializing a set of attracted users (process 3325), tracking cyclic time (process 3330), and resetting cyclic time (process 3372).

Processes 3340 start a new round of executing recursive processes by:
tracking users accessing the source contents (process 3350);
updating the set of attracted users and counting the attracted number Δ of users (process 3360); and
verifying conditions (process 3365) for starting a new process of recursive audience amplification.

Process 3365 re-initiates the entire audience expansion cycle by activating Module-I to re-determine currently attracted audience followed by recursive activation of Module-II and Module-I as described above. Different criteria may be applied for starting a new cycle. For example, a new cycle may be initiated subject to a determination that:
(a) the audience gain exceeds a predefined size threshold Δ*; or
(b) the cyclic time T exceeds a predefined time-interval threshold T*; or
(c) the audience gain exceeds the predefined size threshold Δ* and the cyclic time T exceeds the predefined time interval T*.

If the selected condition (a), (b), or (c) is not satisfied, process 3350 is revisited. Otherwise, the cyclic time T is reset to zero or any reference value (process 3372) and process 3380 is activated.

Initially, at the time of posting the source contents, the number of attracted audience, i.e., the size of the spontaneous audience, is zero. When, according to criterion (a), a count of the spontaneous audience reaches the predefined size threshold Δ*, the recursive audience-expansion process is initiated. Likewise, the recursive audience-expansion process may be initiated under criterion (b) or (c).

Process 3380 executes recursive audience expansion processes where Module-II and Module-I are cyclically activated a number of times depending on the order of the recursive process. Process 3390 communicates information relevant to the source contents to prospective audience determined in process 3380. Resulting audience gain would be determined when processes 3340 are activated to start a new iteration or determine completion of process 3300.

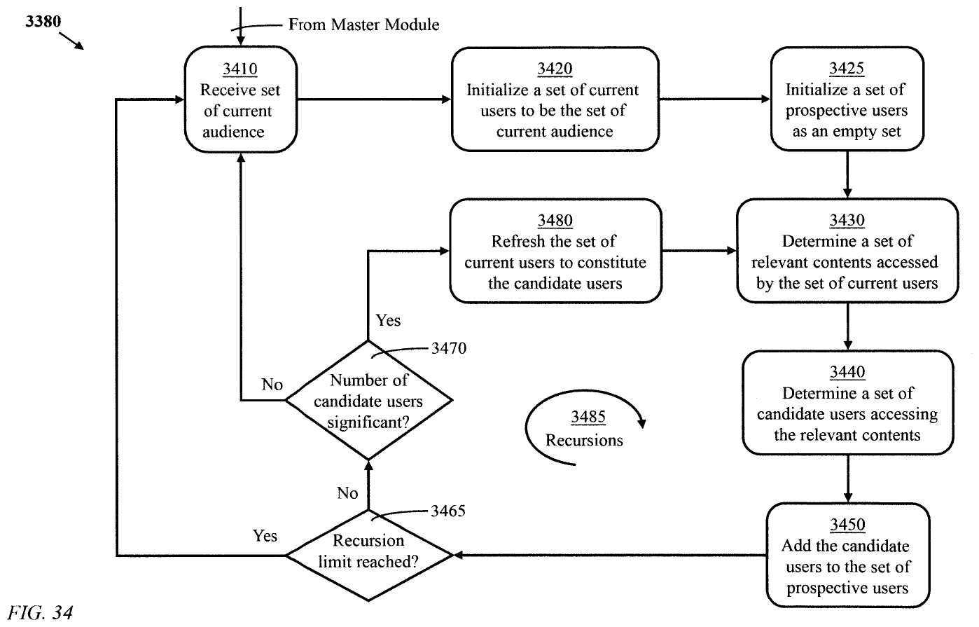

FIG. 34 is a flow chart detailing the recursive audience expansion process 3380. Upon receiving the set of current audience (process 3410) a “set of current users” is initialized to contain the set of current audience (process 3420) and a “set of prospective audience” is initialized as an empty set (process 3425).

Module-II is activated to determine a set of relevant contents accessed by the set of current users (process 3430). Module-I is activated to determine a set of candidate users accessing the relevant contents (process 3440). Process 3450 adds the candidate users to the set of prospective audience. Process 3465 counts recursions 3485 and determines whether a preset limit of the number of recursions has been reached. If the limit has been reached, process 3410 is revisited to start a new sequence of recursive processes. Otherwise, process 3470 is activated to determine whether a significant number of candidate users has been reached. If a significant number has been reached, process 3480 is activated to refresh the set of current users to constitute the candidate users. A recursion 3485 traverses processes 3430, 3440, 3450, 3465, 3470, and 3480.

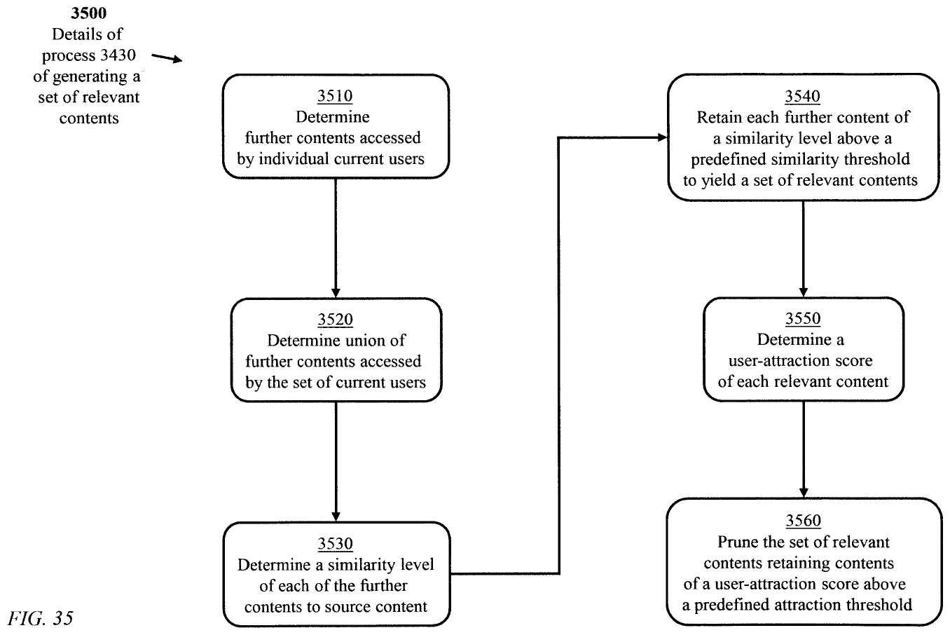

FIG. 35 is a flow chart 3500 detailing process 3430 of determining a set of relevant contents. Process 3510 determines further contents accessed by each current user and process 2520 determines the union of further contents accessed by the set of current users as illustrated in FIG. 29 and FIG. 30. Process 3530 determines a similarity level of each of the further contents to the source content. Process 3540 retains each of the further contents that has a similarity level above a predefined similarity threshold to yield a set of relevant contents. Process 3550 determines a user-attraction score for each of the relevant contents. Process 3560 then prunes the set of relevant contents to retain each of the relevant contents that has a user-attraction score (a gravitation score) above a predefined attraction threshold (gravitation threshold).

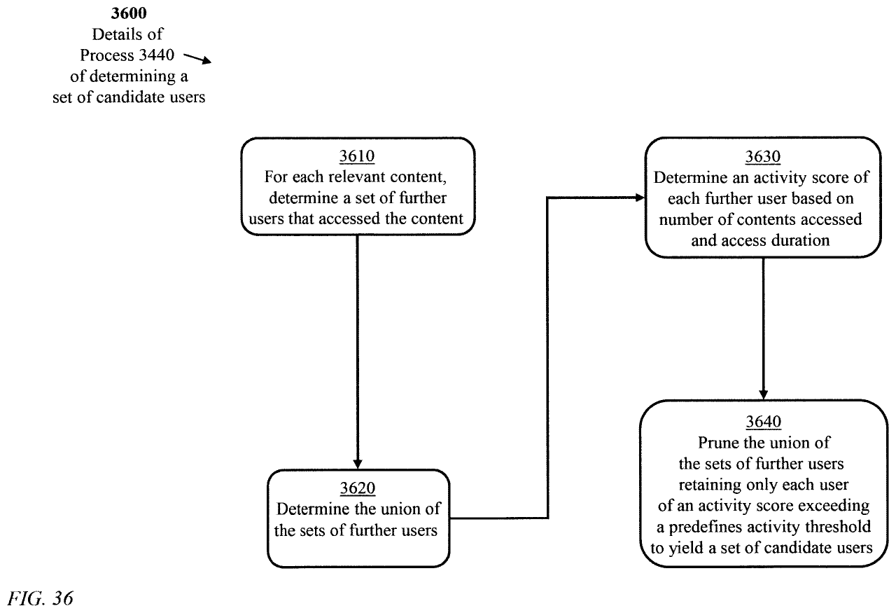

FIG. 36 is a flow chart 3600 of processes of determining candidate users, detailing process 3440. Module-I is activated to determine for each relevant content a respective set of further users that accessed the relevant content (process 3610). Process 3620 then determines the union of sets of further users and process 3630 determines a user-activity score of each further user as a function of the number of accessed contents and access duration; for example, the user activity score may be proportional to the cumulative access time regardless of the number of visits to the source-contents' site or a function that credits the number of visits as well as the cumulative access time. Process 3640 then prunes the sets of further users to retain each of the further users that has a user-activity score exceeding a predefined user-activity threshold as illustrated in FIG. 29 and FIG. 30.

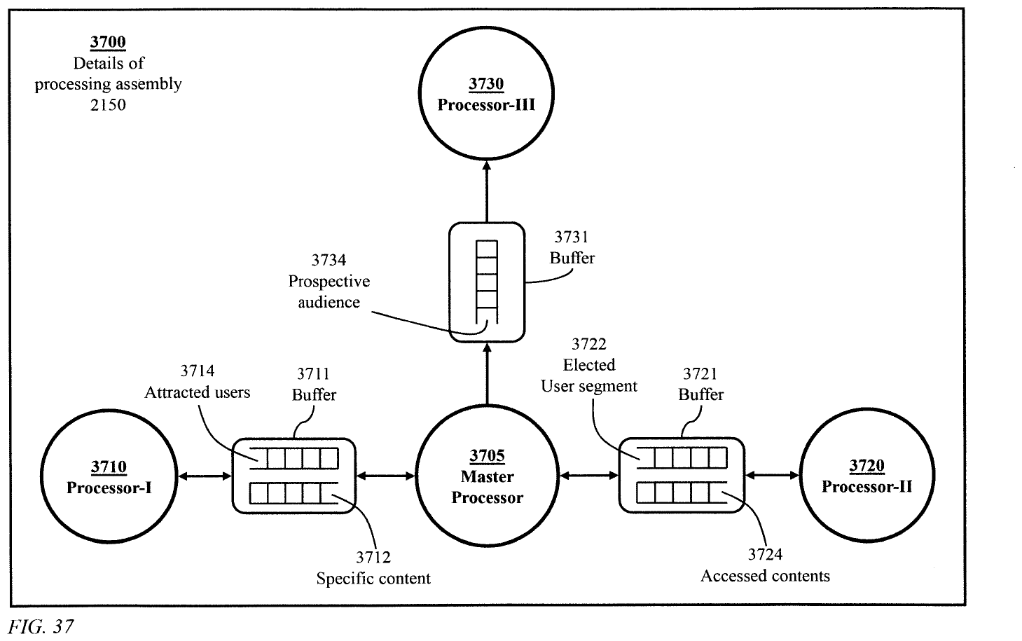

FIG. 37 illustrates a processing assembly 3700, detailing processing assembly 2150, comprising processors, labeled processor-I, processor-II, processor-III, interacting through buffers and a master processor 3705. Processor-I, 3710 executes instructions of Module-I, processor-II, 3720, executes instructions of Module-2, and Processor-III, 3730, executes instructions of Module-III. The term “processor” is used herein to refer to hardware processing/computing devices while the term “module” refers to processor-executable instructions stored in a memory device.

The master processor 3705 communicates with processor-I, 3710, through a buffer 3711. The Master Processor 3705 and Processor-I, 3710, have READ and WRITE access to the buffer 3711. Buffer 3711 is organized into buffer segments 3712 and 3714. Buffer segment 3712 stores data relevant to reference contents and relevant control parameters received from the master processor 3705. Buffer segment 3714 stores information relevant to users attracted to the reference contents resulting from execution of module-I at processor-I.

The master processor 3705 communicates with processor-II, 3720, through a buffer 3721. The Master Processor 3705 and Processor-II, 3720, have READ and WRITE access to the buffer 3721. Buffer 3721 is organized into buffer segments 3722 and 3724. Buffer segment 3722 stores data relevant to a set of reference users and relevant control parameters received from the master processor 3705. Buffer segment 3724 stores data relevant to contents accessed by the set of reference users resulting from execution of module-II at processor-II. Sequential activation of module-II and module-I at processor-II and processor-I yields a set of prospective audience as described above with reference to FIG. 31.

The master processor 3705 communicates with processor-III, 3720, through a buffer 3731 storing data 3734 relevant to prospective audience and source contents. Processor-III executes module-III to communicate information relevant to the source contents to the prospective audience.

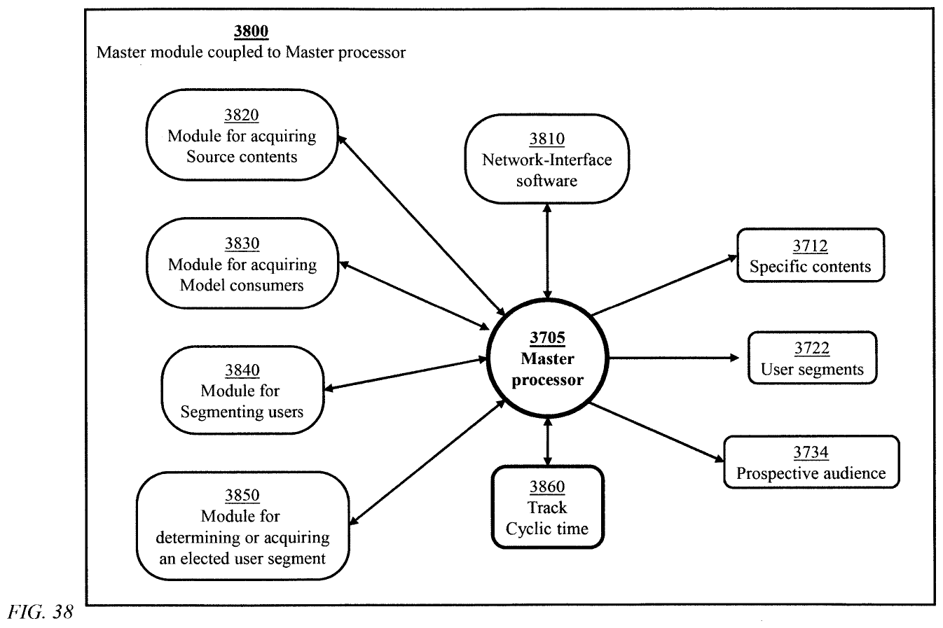

FIG. 38 illustrates details 3800 of the master module and master processor 3705. The master processor 3705 is coupled to memory devices storing:
(a) Network-interface module 3810;
(b) Module 3820 for acquiring source contents;
(c) Module 3830 for acquiring characteristics of model consumers;
(d) Module 3840 for segmenting users based on user traits;
(e) Module 3850 for identifying a target group of users; and
(f) Module 3860 for tracking cyclic time.

The outcome of executing the modules is held in buffers storing specific contents 3712, user segments and/or a selected user segment 3722, data 3734 relevant to prospective audience and source contents, and relevant control data.

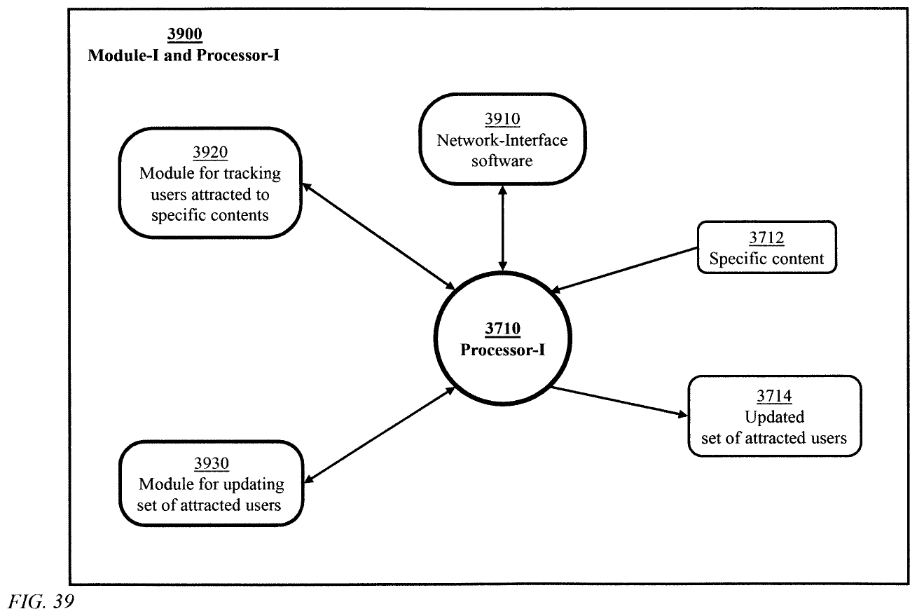

FIG. 39 illustrates details 3900 of module-I, 2010, and processor-I, 3710. Processor-I is coupled to memory devices storing:
(1) Network-interface module 3910;
(2) Module 3920 for tracking users attracted to specified contents
(3) Module 3930 for updating the set of attracted users and determining changes of audience count;
(4) Specified content data 3712; and
(5) Data 3714 relevant to attracted users.

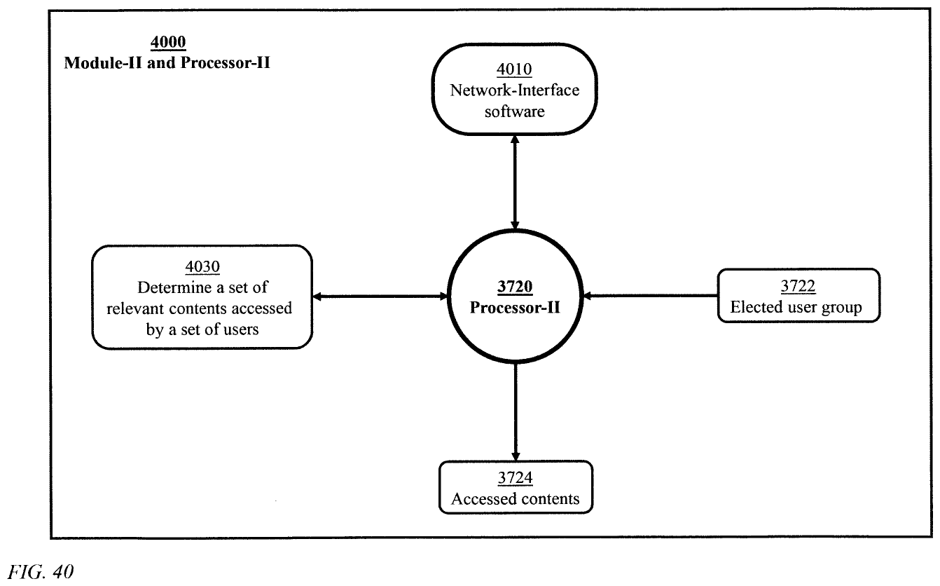

FIG. 40 illustrates details 4000 of module-II, 2020 and processor-II, 3720. Processor-II is coupled to memory devices storing:
(i) A network-interface module 4010;
(ii) Data 3722 relevant to a cluster of users; and
(iii) Module 4030 for determining a set of relevant contents accessed by a given set of users.

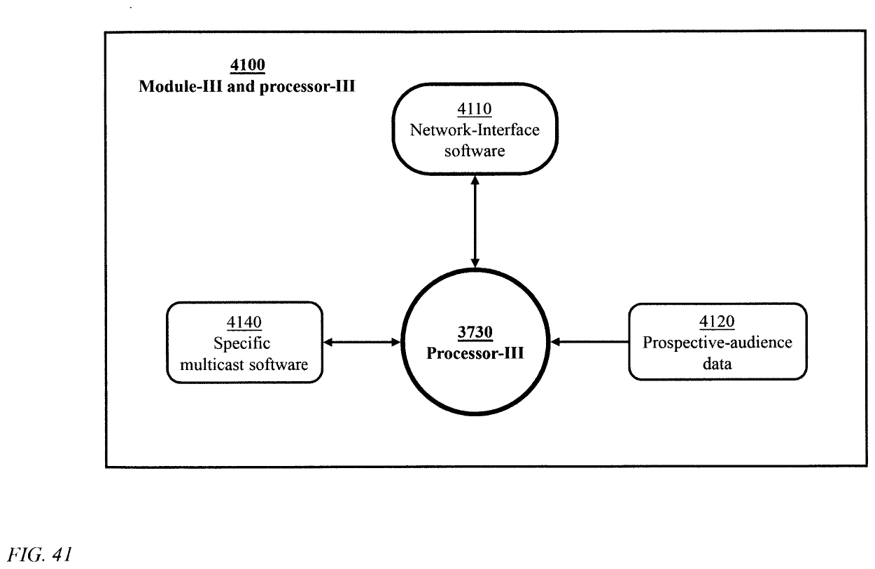

FIG. 41 illustrates details 4100 of module-III, 2030, and processor-III, 3730. Processor-III is coupled to memory devices storing:
(1) Network interface module 4110;
(2) Data 4120 relevant to prospective audience and source contents; and
(3) Module 4140 for multicasting to prospective audience.

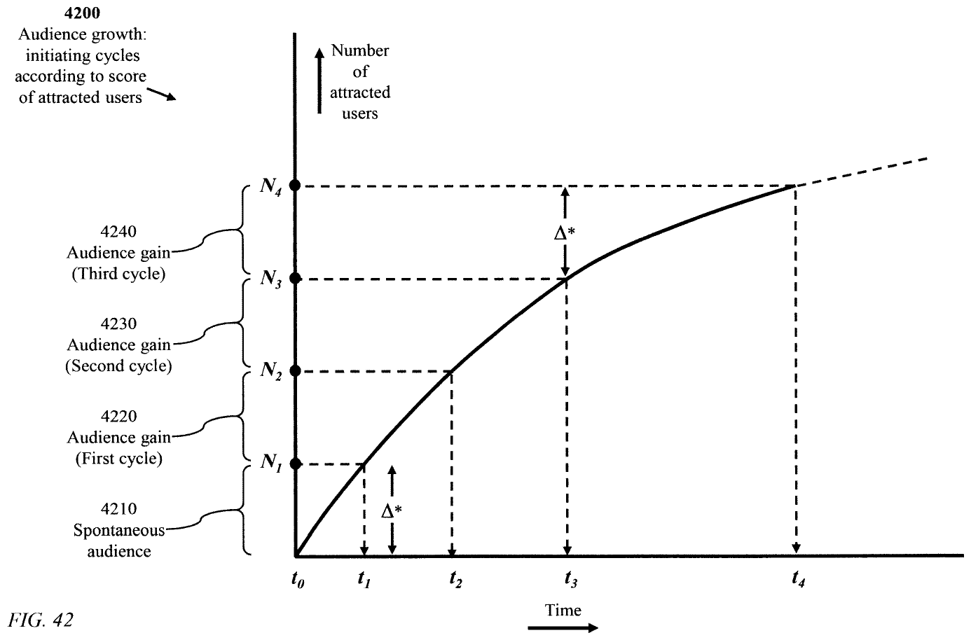

FIG. 42 illustrates audience growth 4200 indicating exemplary variation of audience size where a new audience-expansion cycle is initiated when the audience gain exceeds a predefined size threshold Δ*.

The source contents are posted at time t₀. The size 4210 of spontaneous audience reached a value N₁ equal to or exceeding Δ* at absolute time t₁. A recursive audience-expansion cycle may be initiated at any instant after time t₁. The size N₂ of all attracted audience, including the initial spontaneous audience, where the audience gain 4220, determined as (N₂−N₁), equals or exceeds Δ*, is reached at absolute time t₂. The audience gain 4220 may be attributed to activation of recursive audience-expansion cycle, where content-coupled users are approached, as well as further spontaneous audience that were not approached.

Likewise, an audience gain 4230 is realized after a second audience-expansion cycle, an audience gain 4240 is realized after a third audience-expansion cycle, and so on. As discussed above, a limit on the number of recursions may be imposed as a design parameter.

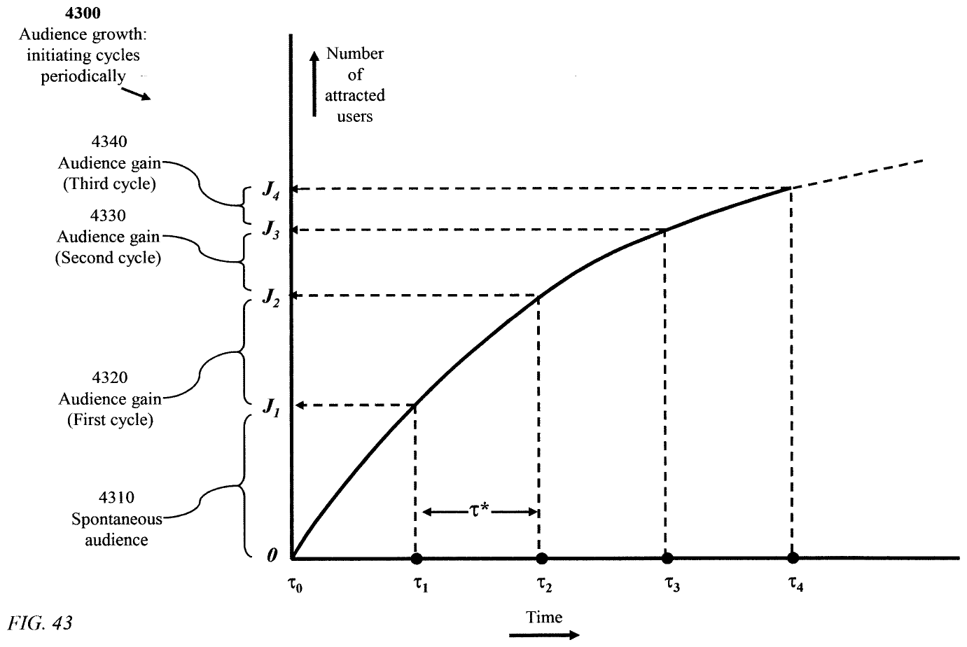

FIG. 43 illustrates audience growth 4300 indicating exemplary variation of audience size where a new audience-expansion cycle is initiated when the cyclic time equals or exceeds a predefined time-interval threshold τ*.

The source contents are posted at time τ₀. The size 4310 of spontaneous audience reached a value J₁ at absolute time τ₁ where the time interval (τ₁-τ₀) equals or exceeds τ*. A recursive audience-expansion cycle may be initiated at any instant after time τ₁. The size 4310 of all attracted audience reached a value J₂ at absolute time τ₂ where the time interval (τ₂−τ₁) equals or exceeds τ*. A recursive audience-expansion cycle may be initiated at any instant after time τ₂. The audience gain 4320 may be attributed to both the activation of recursive audience-expansion cycle, where content-coupled users are approached, and further spontaneous audience that were not approached.

Likewise, an audience gain 4330 is realized after a second audience-expansion cycle activated during the period (τ₃-τ₂), which at least equals τ*, an audience gain 4340 is realized after a third audience-expansion cycle during the period (τ₄-τ₃), which at least equals τ*, and so on. A limit on the number of recursions may be imposed as a design parameter.

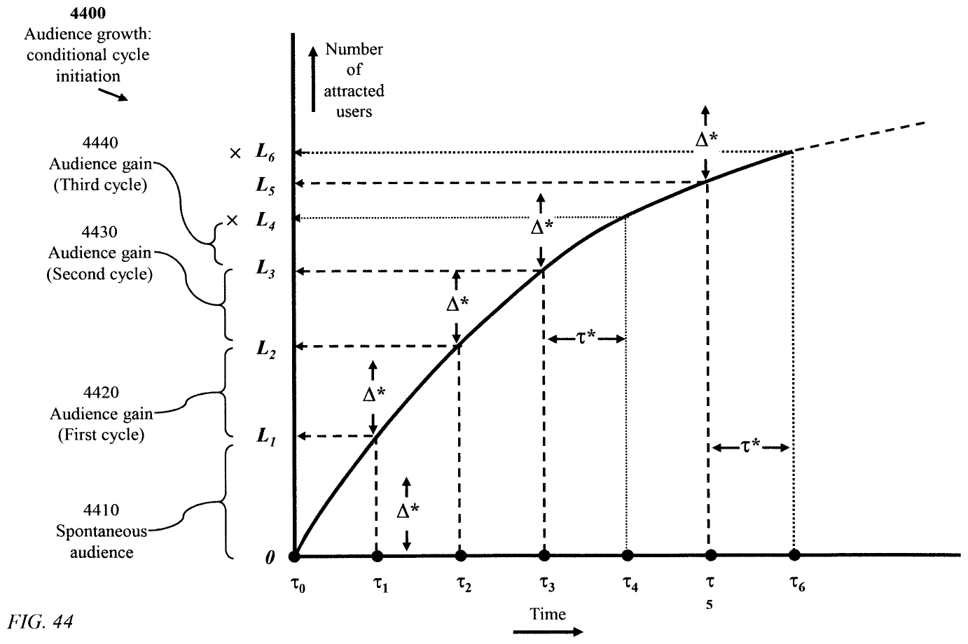

FIG. 44 illustrates audience growth 4400 indicating exemplary variation of audience size with time where a new audience-expansion cycle is initiated when the audience gain equals or exceeds a predefined size threshold Δ* and the cyclic time equals or exceeds a predefined time-interval threshold τ*.

The source contents are posted at time to. The size 4410 of spontaneous audience reached a value L₁ at absolute time τ₁ where the time interval (τ₁-τ₀) equals or exceeds τ* and the value L₁ equals or exceeds Δ*. Hence, a recursive audience-expansion cycle may be initiated at any instant after time τ₁. The size of all attracted audience reached a value L₂ at absolute time τ₂ where the time interval (τ₂-τ₁) equals or exceeds τ*. The audience gain 4420, determined as (L₂-L₁), equals or exceeds Δ*, hence, a recursive audience-expansion cycle may be initiated at any instant after time τ₂.

The audience gain 4420 may be attributed to both the activation of recursive audience-expansion cycle, where content-coupled users are approached, and further spontaneously attracted users that were not approached.

Likewise, an audience gain 4430, determined as (L₃-L₂), is realized after a second audience-expansion cycle activated during the period (τ₃-τ₂), which at least equals τ*. The audience gain 4430 equals or exceeds Δ*, hence, a new recursive audience-expansion cycle may be initiated at any instant after time τ₃.

An audience gain 4440, determined as (L₄-L₃), is realized after a third audience-expansion cycle activated during the period (τ₄-τ₃), which at least equals τ*. The audience gain 4440, however, is less than Δ*, hence, initiating a new recursive audience-expansion cycle is delayed to time instant τ₅, where (τ₄-τ₃) at least equals τ*. The audience gain (L₅-L₃), determined at time instant τ₅, exceeds Δ*, hence, a new recursive audience-expansion cycle may be initiated at any instant after time τ₅.

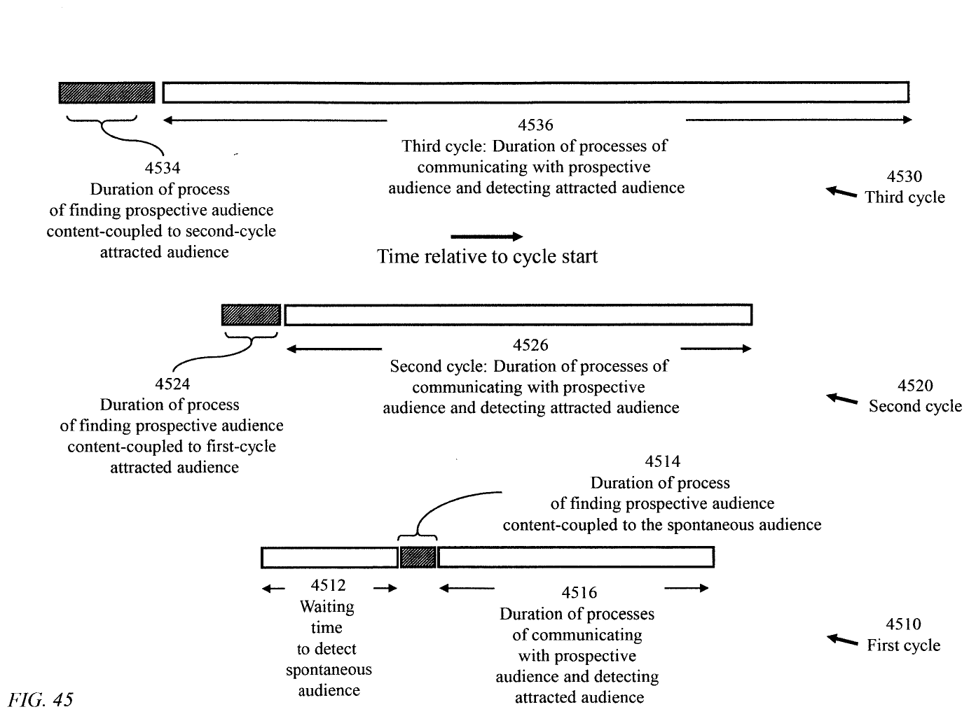

FIG. 45 illustrates timing of recursive audience amplification processes. Initially, source contents are posted in a social medium accessible to a plurality of users. During an observation time 4512, Module-I detects users that spontaneously accessed at least one of the contents. If Module-I determines that the size of the spontaneous audience is significant, based on a predefined content-gravitation threshold, a first cycle 4510 of audience expansion is initiated where Module-II and Module-I are activated to determine first-stratum prospective audience, i.e., users that are likely to respond to a suggestion to access the source contents.

Module-II starts a process of finding first-stratum contents, defined as contents, other than the source contents, that the spontaneous audience accessed. Module-I is then activated to find first-stratum prospective audience, defined as users that are content-coupled to the spontaneous audience, i.e., users that accessed the first-stratum contents. The processes of Module-II and Module-I take place during a transient time-interval 4514. During the transient time-interval 4514, the size of spontaneous audience may increase; however, finding content-coupled users to users attracted during time-interval 4514 is not feasible in the first stratum but will be captured in an iterative procedure where the multi-stratum processes are repeated (FIG. 2, FIG. 3).

Following the time-interval 4514, Module-III is activated to communicate with the first-stratum prospective audience while Module-I detects responsive users, herein referenced as “first-stratum induced audience”. Upon completion of the communication process, the first stratum terminates to start a second cycle 4520 after an interval of time 4516, at least equal to a predefined value.

In the second cycle 4520, Module-II starts a process of finding second-stratum contents, defined as contents, other than the first-stratum contents, that the first-stratum induced audience accessed. Module-I is then activated to find second-stratum prospective audience, defined as users that are content-coupled to the first-stratum induced audience, i.e., users that accessed the second-stratum contents. The processes of Module-II and Module-I take place during a transient time-interval 4524. During the transient time-interval 4524, the size of spontaneous audience and induced audience may increase; however, finding content-coupled users to users attracted during time-interval 4524 is not feasible in the second stratum but will be captured in an iterative procedure where the multi-stratum processes are repeated (FIG. 2, FIG. 3).

Following the time-interval 4524, Module-III is activated to communicate with the second-stratum prospective audience while Module-I detects responsive users, herein referenced as “second-stratum induced audience”. Upon completion of the communication process, the second cycle 4520 terminates to start a third cycle 4530 after an interval of time 4526, at least equal to a predefined value.

In the third cycle 4530, Module-II starts a process of finding third-stratum contents, defined as contents, other than the second-stratum contents, that the second-stratum induced audience accessed. Module-I is then activated to find third-stratum prospective audience, defined as users that are content-coupled to the second-stratum induced audience, i.e., users that accessed the third-stratum contents. The processes of Module-II and Module-I take place during a transient time-interval 4534. During the transient time-interval 4534, the size of spontaneous audience and induced audience may increase; however, finding content-coupled users to users attracted during time-interval 4534 is not feasible in the third stratum but will be captured in an iterative procedure where the multi-stratum processes are repeated (FIG. 2, FIG. 3).

Following the time-interval 4534, Module-III is activated to communicate with the third-stratum prospective audience while Module-I detects responsive users, herein referenced as “third-stratum induced audience”. Upon completion of the communication process, the third cycle 4530 terminates to start a subsequent cycle—if desired—after an interval of time 4536, at least equal to a predefined value.

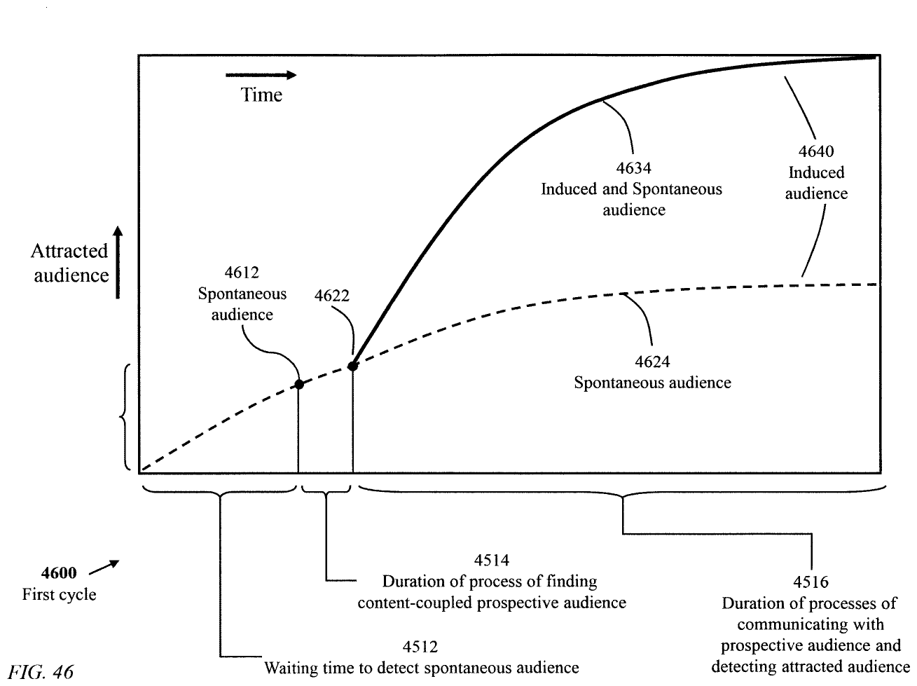

FIG. 46 illustrates exemplary audience growth 4600 during a first cycle of audience amplification. During an observation period 4512, following posting the source contents in a social medium, Module-I detects spontaneous audience that accessed the source contents. In the exemplary case of FIG. 46, the size 4612 of the spontaneous audience detected during observation period 4512 is considered significant. Hence, during transient time interval 4514, Module-II is activated to find first-stratum contents and Module-I is activated to find first-stratum prospective audience as described above with reference to FIG. 45.

During transient time interval 4514, the size of the spontaneous audience may grow from the value referenced as 4612 to a value referenced 4622.

Without implementing the audience-amplification processes, the size of the spontaneous audience may continue to grow beyond the observation interval 4512 as indicated by the hypothetical extrapolation 4624. Implementation of the audience-amplification processes aims at realizing the envisaged growth 4634, which combines the spontaneous audience and induced audience 4640. The induced audience 4640 is attributed to communication with prospective audience.

After realizing a first-stratum induced audience, the recursive expansion procedure described above may continue until it is determined that further audience gain is unlikely. According to one embodiment, a timer is cyclically reset to a reference reading (preferably zero) after a predefined interval of time defining a timer cycle and processes (i) to (iv) below are performed:
(i) determining a set of K^{th}-stratum induced audience, K>1, during each of successive timer cycles;
(ii) determining audience gain as a count of the induced audience during each timer cycle;
(iii) determining a trend of audience gain over successive timer cycles; and
(iv) starting a new recursion subject to a determination that the trend satisfies a respective predetermined criterion; otherwise the recursive-expansion process is considered complete.

It is noted that the methods described above may be implemented by an engine employing a single hardware processor or an engine employing multiple hardware processors as illustrated in FIG. 37. The term “processor” is used herein to refer to a hardware entity while the term “module” refers to software instructions.

The disclosed methods and systems of embodiments of the present invention enable focused dissemination of source contents to appropriate audience that are likely to benefit from the contents. This is realized by using techniques of pursuing similar-interest content-coupled users, segmenting users according to selected traits or according to similarity to a set of model consumers, and pruning similar-interest users according to individual activity scores. Methods described above result in significantly enhancing audience expansion as well as reducing redundant communications, memory storage requirements, and computational effort, thus making significant technical improvements to the entire hardware system. An exemplary energy efficient apparatus based on the method has been disclosed. Reducing the computational effort is of paramount importance since the apparatus may engage multiple social media.

Systems and apparatus of the embodiments of the invention may be implemented as any of a variety of suitable circuitry, such as one or more microprocessors, digital signal processors (DSPs), application-specific integrated circuits (ASICs), field programmable gate arrays (FPGAs), discrete logic, software, hardware, firmware or any combinations thereof. When modules of the systems of the embodiments of the invention are implemented partially or entirely in software, the modules contain a memory device for storing software instructions in a suitable, non-transitory computer-readable storage medium, and software instructions are executed in hardware using one or more processors to perform the techniques of this disclosure.

It should be noted that methods and systems of the embodiments of the invention and data sets described above are not, in any sense, abstract or intangible. Instead, the data is necessarily presented in a digital form and stored in a physical data-storage computer-readable medium, such as an electronic memory, mass-storage device, or other physical, tangible, data-storage device and medium. It should also be noted that the currently described data-processing and data-storage methods cannot be carried out manually by a human analyst, because of the complexity and vast numbers of intermediate results generated for processing and analysis of even quite modest amounts of data. Instead, the methods described herein are necessarily carried out by electronic computing systems having processors on electronically or magnetically stored data, with the results of the data processing and data analysis digitally stored in one or more tangible, physical, data-storage devices and media.

Although specific embodiments of the invention have been described in detail, it should be understood that the described embodiments are intended to be illustrative and not restrictive. Various changes and modifications of the embodiments shown in the drawings and described in the specification may be made within the scope of the following claims without departing from the scope of the invention in its broader aspect.

1. A method of audience amplification comprising:
employing at least one processor for:
posting source contents in a social medium serving a plurality of users and providing a plurality of contents;
detecting a set of spontaneous audience that individually accessed at least one of said source contents;
determining first-stratum contents that said spontaneous audience accessed;
content-pruning said first-stratum contents to yield first-stratum relevant contents;
detecting first-stratum users that accessed said first-stratum relevant contents;
user-pruning said first-stratum users to yield first-stratum prospective audience;
communicating said source contents to said first-stratum prospective audience; and
tracking said first-stratum prospective audience to identify first-stratum induced audience.

2. The method of claim 1 wherein said determining comprises forming said first-stratum contents as a union of sets of contents accessed by individual users of said spontaneous audience.

3. The method of claim 1 wherein said detecting comprises forming said first-stratum users as a union of sets of users that accessed individual contents of said first-stratum relevant contents.

4. The method of claim 1 further comprising:
determining a gravitation score of each of said first-stratum contents; and
eliminating each first-stratum content having a gravitation score below a predefined gravitation threshold to yield said first-stratum relevant contents;
said gravitation score being a count of users that accessed said each first-stratum content.

5. The method of claim 1 wherein said content-pruning comprises:
determining a content-similarity level of each of said first-stratum contents to said source contents; and
eliminating each first-stratum content having a content-similarity level below a predefined content-similarity threshold.

6. The method of claim 1 wherein said user-pruning further comprises:
determining an activity score of each of said first-stratum users; and
eliminating each first-stratum user having an activity score below a predefined activity threshold;
said activity score being a count of contents of said first-stratum relevant contents that said each first-stratum user accessed.

7. The method of claim 6 wherein said user-pruning further comprises:
determining a user-similarity level of each of said first-stratum users to said spontaneous audience; and
eliminating each first-stratum user having a user-similarity level below a predefined user-similarity threshold.

8. The method of claim 6 further comprising:
segmenting said first-stratum users into a predefined number of clusters of users; and
selecting one of the clusters of users as a relevant cluster.

9. The method of claim 8 wherein said user-pruning further comprises retaining only first-stratum users within said relevant cluster to yield said first-stratum prospective audience.

10. The method of claim 8 wherein said segmenting is based on characterizing each of said first-stratum users by respective descriptors of predefined descriptor types.

11. The method of claim 6 wherein said user-pruning further comprises:
determining a user-similarity level of each user of said first-stratum users to a predefined set of model consumers; and
eliminating each first-stratum user having a user-similarity level below a predefined user-similarity threshold.

12. (canceled)

13. The method of claim 1 wherein said communicating comprises multicasting said source contents to said first-stratum prospective audience.

14. The method of claim 1 further comprising:
tracking said first-stratum prospective audience;
determining second-stratum contents that said first-stratum prospective audience accessed;
content-pruning said second-stratum contents to yield second-stratum relevant contents;
detecting second-stratum users that accessed said second-stratum relevant contents;
user-pruning said second-stratum users to yield second-stratum prospective audience;
communicating said source contents to said second-stratum prospective audience; and
tracking said second-stratum prospective audience to identify second-stratum induced audience.

15. The method of claim 1 further comprising:
tracking said first-stratum induced audience;
determining second-stratum contents that said first-stratum induced audience accessed;
content-pruning said second-stratum contents to yield second-stratum relevant contents;
detecting second-stratum users that accessed said second-stratum relevant contents;
user-pruning said second-stratum users to yield second-stratum prospective audience;
communicating said source contents to said second-stratum prospective audience; and
tracking said second-stratum prospective audience to identify second-stratum induced audience.

16. A method of audience amplification comprising:
employing at least one processor for:
posting source contents in a social medium serving a plurality of users and providing a plurality of contents;
detecting, over a specified time interval, a set of spontaneous audience that individually accessed at least one of said source contents;
populating a set of augmented audience to comprise said set of spontaneous audience; and
performing processes of:
determining first-stratum contents that said augmented audience accessed;
content-pruning said first-stratum contents to yield relevant contents;
detecting first-stratum users that accessed said relevant contents;
user-pruning said first-stratum users to yield prospective audience;
communicating said source contents to said prospective audience;
tracking said prospective audience to identify induced audience; and
adding said induced audience to said set of augmented audience.

17. The method of claim 16 further comprising:
setting a cyclic timer to restart after a predefined interval of time defining a timer cycle;
determining audience gain as a count of said induced audience during each timer cycle;
determining a trend of audience gain over successive timer cycles; and
repeating said performing subject to a determination that said trend satisfies a respective predetermined criterion.

18. The method of claim 16 wherein said content-pruning comprises processes of:
determining for each of said first-stratum contents;
a gravitation score; and
a level of content-similarity to said source contents;
and
eliminating each first-stratum content having at least one of:
a gravitation score below a predefined gravitation threshold; and
a level of content-similarity below a predefined content-similarity threshold;
said gravitation score being a count of users that accessed said each first-stratum content.

19. The method of claim 16 wherein said user-pruning comprises:
determining for each of said first-stratum users:
an activity score; and
a level of user-similarity to a predefined set of model consumers;
and
eliminating each first-stratum user having at least one of:
an activity score below a predefined activity threshold; and
a user-similarity level below a predefined user-similarity threshold;
said activity score being a count of said first-stratum relevant contents that said each first-stratum user accessed.

20-24. (canceled)

25. An apparatus for audience amplification coupled to a social medium serving a plurality of users and providing a plurality of contents, the apparatus comprising:
processors and memory devices storing processor executable instructions causing said processors to:
post a source content in said social medium;
identify initial users that spontaneously accessed said source content over a specified time interval;
populate a set of augmented audience to comprise said set of initial users; and
perform an iterative procedure to:
acquire first-stratum contents that said augmented audience accessed;
filter said first-stratum contents to retain relevant contents;
detect first-stratum users that accessed said relevant contents;
prune said first-stratum users to yield prospective audience;
communicate said source contents to said prospective audience;
track said prospective audience to identify induced audience; and
add said induced audience to said set of augmented audience.

26. The apparatus of claim 25 further comprising a cyclic timer configured to restart after a predefined interval of time defining a timer cycle, wherein said processor executable instructions cause said processors to:
determine audience gain during each timer cycle;
determine a trend of audience gain over successive timer cycles; and
continue said iterative procedure while said trend satisfies a respective predetermined criterion.
